(19) United States
(12) Patent Application Publication
(10) Pub. No.: US 2004/0026935 A1
(43) Pub. Date: Feb. 12, 2004

(54) Door and window securement apparatus and method of use thereof

(76) Inventor: Gordon Tang, Bellevue, WA (US)

Correspondence Address: Robert M. Storwick, PO Box 386, Mercer Island, WA, 98040, US

(21) Appl. No.: 10/626,992

(22) Filed: Jul. 24, 2003

Related U.S. Application Data
(63) Continuation-in-part of application No. 10/355,994, filed on Jan. 30, 2003.
Application No. 10/355,994 is a continuation-in-part of application No. 09/515,968, filed on Feb. 29, 2000, now abandoned.
Application No. 09/515,968 is a continuation-in-part of application No. 09/430,109, filed on Oct. 29, 1999, now abandoned.

(51) Int. Cl. E05C 19/18

(52) U.S. Cl. 292/292

(57) ABSTRACT

A securement apparatus and methods of use thereof for selectively securing and barring one or more hinged doors or windows against opening and, thereby, prevent unwanted and/or unauthorized entry therethrough. The apparatus is effectively and operatively secured to the door or window frame, jamb and/or studs that define an opening without necessarily defacing, marring or damaging the door, window, frame, jamb, trim or molding during installation, use or removal thereof beyond that caused by the installation and/or removal of conventional door or window hardware. The apparatus generally includes a bracket that may be secured to the jamb behind a strike plate using the same screws, bolts or nails that secure the strike plate to the jamb. The apparatus further includes a barrier that selectively bars or prevents the pivotal movement of the closed door or window.

### CROSS-REFERENCE TO OTHER APPLICATIONS

This application is a continuation-in-part of co-pending U.S. patent application Ser. No. 10/355,994, filed Jan. 30, 2003, which is a continuation-in-part of co-pending U.S. patent application Ser. No. 09/515,968, filed Feb. 29, 2000, which is a continuation-in-part of U.S. patent application Ser. No. 09/4340,109, filed Oct. 29, 1999.

### COPYRIGHT NOTICE

© Copyright 2003, Robert M. Storwick and James R. Vance. All rights reserved.

A portion of the disclosure of this patent document contains material that is subject to copyright protection. The copyright owners have no objection to the facsimile reproduction by anyone of the patent document or the patent disclosure, as it appears in the Patent and Trademark Office patent files or records, but otherwise reserve all copyrights whatsoever.

1. Technical Field

This invention relates to improved door and window securement devices. More particularly this invention relates to door and window barring devices that do not necessarily require that the door, window, jamb or frame molding be defaced, marred or damaged during installation, use or removal therefrom beyond that caused by installing traditional door or fenestration hardware.

2. Background Art

For centuries various forms of barriers and locks were used to control the opening, closing and locking of hinged doors and windows. For example, during medieval times various sliding, pivoting and dropping bars were used to bar gates, doors and windows.

Within our modern era, such barring devices have not greatly changed. The following disclosures teach various mechanisms and devices for barring a modern door: Patterson (U.S. Pat. No. 2,665,935; issued Jan. 12, 1954); O'Neal et al. (U.S. Pat. No. 4,429,911; issued Feb. 7, 1984); Barnhill (U.S. Pat. No. 4,462,625; issued Jul. 31, 1984); Cole, Jr. (U.S. Pat. No. 4,548,436; issued Oct. 22, 1985); Wicks, Sr. (U.S. Pat. No. 4,601,503; issued Jul. 22, 1986); and Sweet (U.S. Pat. No. 5,340,172; issued Aug. 23, 1994).

With nearly every door within the modern world provided with a keyed lock, one could legitimately inquire concerning the need or lack thereof for a bar to block the pivotal movement of a hinged door. The following discussion and the subject matter of this invention address that inquiry.

When a person rents a new apartment or condominium, the renter is often unsure of how many persons might have a copy of the key to the renter's exterior door lock(s). For example, previous tenants, roommates, boyfriends, girlfriends and/or relatives of previous tenants, acquaintances of roommates of previous tenants, building maintenance personnel, building managers and supervisors, landlords, etc., all might have a key to the front door lock and/or back door lock.

Upon moving into the apartment or condominium, the building owner or superintendent might agree to replace or re-key the lock. However, there are still numerous persons that might still have access to copies of the key kept by the owner and building superintendent.

Renters often do not want to incur the cost of having to re-key their door locks. This is particularly true when the lease agreement requires that the owner and superintendent be given one or more copies of the key(s) to the new locks. Given access to such key duplicates, anyone could easily gain access to the apartment or condominium without the knowledge and permission of the renter.

Renters are particularly concerned about potential unauthorized access to their apartment or condominium when the renters are still personally within the dwelling. Occurrences of assault and rape upon young and old tenants alike within their own apartments and condominiums are often reported by the news media. Such reports further intensify the insecurity and concern experienced by renters. This is particularly true for the elderly, disabled, handicapped, all ages of women, and all those who may feel vulnerable or helpless to the unpredictable actions of ruthless criminals.

In an attempt to provide a semblance of peace of mind, renters will often purchase and install small casement latches, small surface slide bolts and/or small Dutch-door bolts. Such devices typically each have some form of an additional door plate or bracket and a jamb plate or bracket that are independently screwed into the door and onto the external, frame molding of the door jamb, respectively. Such devices are well known within the art and commonly appear on apartment doors and door frame moldings.

Another device commonly used by renters is a small chain lock, which has a small knob attached to one end of a short length of chain that can be moved into or out of a receiving channel of a door plate. The door plate is independently screwed onto the interior face of the door. The receiving channel is found within the door plate. The other end of the chain is secured to a jamb plate that is independently screwed onto the exterior face of the door jamb or door frame molding. Such chain locking device is also well known within the art and frequently appears on apartment doors and door frame moldings.

Another device that is readily available in the marketplace is a hasp. The hasp has a small hinge, one side of which is independently screwed onto the door frame molding. A swivel plate or staple, having a swivel eye, is independently secured to the door. The free end of the hinge has a slot through which the swivel eye may pass. When desired, the free end of the hinge may be pivoted into engagement with the swivel eye of the swivel plate. The swivel eye can then be turned into either a locked or unlocked position to provide additional security to the door or permit the door to be opened.

The aforementioned devices are largely ineffective in deterring the unwanted entrance of an intruder through a door or window. Furthermore, use of such ineffective devices necessarily requires that the door, door jamb and door frame molding be damaged, marred and defaced beyond simply installing standard, traditional door hardware. Traditional door hardware generally comprises one or more hinges, a door handle with a moyable bolt secured to the door and a striker plate secured to the door frame that the bolt engages.

Similarly, if such devices are used on a window, the window frame, window frame casing, and window frame molding are damaged, marred and defaced beyond simply installing standard, traditional window hardware. Traditional window hardware generally comprises one or more hinges, a window handle with a movable bolt secured to the window and a striker plate secured to the window frame that the bolt engages.

By necessity, such ineffective devices must be independently secured to the door, window, door frame and/or window frame, requiring additional holes and screws to be placed therein. In other words, such defacement is necessary because each of such devices must be independently screwed onto the door and the door frame molding, or onto the window and window frame molding.

The type of screws used to attach such devices are usually very short and not very strong. They do not get a very good bite into the wood door, window, frame or casement. Furthermore, the orientation of such screws, with respect to movement of the door or window, permit them to be pulled out quite easily. Consequently, the screws can be very easily ripped or torn from their attachment to the door, window, door frame, window frame and casement.

In addition to the lack of safety such devices provide, such devices are usually used much to the chagrin and dismay of building owner(s) who must try to repair the damage after such devices are either accidentally and/or intentionally removed or pulled from their attachment to the door, door frame molding, window or window frame molding.

Unauthorized use of such devices by a renter may even violate the terms of the renter's lease agreement, exposing the renter to premature termination of his or her lease.

It is reemphasized that such devices do not provide adequate protection against intrusion by unwanted persons. Such devices can often be rendered ineffective by an intruder using a credit card, a knife blade, a length of wire, or another object to move and disengage these simple locking devices from their engaged or quasi-locked positions.

Alternatively, the door can be simply pushed to tear or rip such devices from either or both the door, door frame molding, window and/or window frame molding. For example, such devices are generally and nearly universally ineffective in stopping an intruder that hits the door or window with his or her foot, body or other object. When this occurs, such devices just simply break off or pull out of the door, door frame molding, window and/or window frame molding.

Thus far, the discussion has primarily focused upon renters and homeowners. Similar problems exist for the owners and patrons of hotels and motels. A supplemental locking device which is commonly found within newer hotels and motels is somewhat similar to a hasp discussed above. In essence one end of a pivotal arm or rod is secured to the door frame. A receiving bracket is secured to the door. When the door is closed, the pivotal arm or rod can be moved to engage the receiving bracket on the door. In this engaged position, the door can be partially opened with the pivotal arm or rod still being engaged within the receiving bracket. If the door is closed and the pivotal arm or rod is moved away from the door, the locking mechanism is disengaged and the door can be completely opened.

If the door is opened and the pivotal arm or rod is moved toward the door opening, when the door is closed, the door will impact against the pivotal arm or rod. Within the hotel and motel industry, patrons and maintenance personnel often use this blocking feature to prevent the door from closing and automatically locking behind them.

Here again, such locking mechanism is independently secured to the door and door frame, requiring additional holes to be placed within the door and door frame.

Furthermore, the effectiveness of such a locking mechanism is still in question. The old adage states that a chain is only as strong as its weakest link. Here, as with all of the other preceding locking devices, the weakest link is generally the connection between the screws and the locking device. If the screws can be easily pulled out of the frame or door, the locking device is not an effective deterrent to unauthorized entry.

It is believed that the above-listed information and devices, whether taken alone or in combination, neither anticipate nor render obvious the current invention. The foregoing explanation does not constitute an admission that such information or devices are relevant or material to the appended patent Claims. Rather, such information and devices relate only to the general field of the current disclosure.

### DISCLOSURE OF INVENTION

Owners and maintenance personnel of large apartment buildings often face what seems to be a daily task of having to provide tenants with adequate protection and also repair damage caused by such ridiculously ineffective devices as discussed above. The cost to repair doors and door jambs is significantly higher than providing tenants with good locks.

Providing tenants with good locks, however, does not stop the use of such ineffective devices from appearing on the doors, door jambs, windows and window jambs of apartments and condominiums preciously for the reasons stated above. Consequently, there is a strong need to find a way that tenants can both be safe and secure and feel safe and secure.

In essence, the current invention provides effective, independent means for securing a hinged door and/or window against unauthorized opening irrespective of whether or not a keyed lock and tumbler handle locking system is used.

Use of the phrase “independent means for securing a hinged door and/or window” in the preceding paragraph is intended to convey that this invention does not rely upon the operability or reliability of a standard key and tumbler lock set as commonly found within a lockable door knob or door handle, or which is found within a deadbolt locking system. Rather, the apparatus of this invention may be used to secure a hinged door and/or window against opening irrespective of whether or not a keyed lock and tumbler door or window handle system are used or even attached to the door or window.

The current invention can be used on newly manufactured and hung door frames, door jambs, window frames and window jambs.

Alternatively, this invention can be placed upon and used to retrofit preexisting door frames, door jambs, window frames and window jambs to include means or added or supplemental means for securing the door or window against opening.

This invention can be used on both interior and exterior doors and windows. This invention is generally used to prevent the door or window from opening inwardly from a closed position.

This invention may be secured to a door frame, door jamb, window frame or window jamb using the existing screws and/or screw holes already located within the installed door frame, door jamb, window frame or window jamb. The drilling or creating of undesirable additional holes is not necessarily needed nor required.

With this invention properly secured, the door, the door frame, the door jamb, the window, the window frame and the window jamb need not be further defaced, marred or damaged with an entirely new set of screw holes. Rather, the existing screw holes that are already placed therein and used or would normally appear therein can be utilized. More particularly, the same screws or longer screws that would otherwise hold the strike or striker plate in place can also be used to hold the apparatus of this invention in place.

If desired, alternatively, this invention could be independently secured to the door frame or window frame. For example, if a user wanted the apparatus of this invention to be positioned at a height above the floor that is different from where the strike or striker plate is located, this invention could be secured independently to the door frame or window frame using its own screws, nails, bolts or welds. Such an attachment, however, is not advised since additional holes would generally have to be drilled into the door frame or window frame for attachment of the apparatus, or welding damage may occur. For example, there could be some situations, such as in the construction of a new hotel with metal door frames, the owner may desire to use this invention in an independent manner, without having it positioned near to the door strike or striker plate.

Within the preferred embodiment of this invention, the apparatus is secured by using replacement, relatively-long screws that pass through not only the millwork but also into the door or window casement, including the jamb and/or the vertical or upright studs that generally define the doorway or window opening. This type of installation structure gives this invention much greater strength as compared to the aforementioned security devices which use small surface screws that have a length of only about one-half inch to three-quarters of an inch and generally do not extend deeper than the thickness of the thin, outer, door molding.

By express design, this invention utilizes the full sheer strength of the inserted screws, rather than simply the pull-out strength of the wood surrounding the shallowly inserted face screws used within the old art.

The apparatus of this invention is compact, unobtrusive, efficient, reliable, reusable, durable and rugged. For durability, strength and to match the other hardware on or about the door or window, the apparatus is preferably manufactured from metal, such as from brass, steel, brass-coated steel, chrome-coated steel, or any other desired metal. Of course, the apparatus of this invention can similarly be manufactured from other materials, such as from plastic, laminated resinous materials, compressed materials, graphite, etc., and have other colors, texture and strength as the circumstances require.

This invention is extremely inexpensive and economic.1 to manufacture. Traditional and/or nontraditional manufacturing apparatus and procedures may be used to manufacture the apparatus of this invention without necessarily requiring significant alteration thereto to accomplish the purposes taught herein. For example, the apparatus of this invention may be effectively practiced by using one or more of several different manufacturing techniques or processes, including but not limited to: stamping, milling, welding, shaping, grinding, abrasive-jet machining (AJM), laser-beam machining (LBM), electron-beam machining (EBM), water jet machining, laminating, injection molding, rotational molding, spray molding, vacuum molding, compression molding, expansion molding, pour molding, recess molding, shell molding, plaster molding, lost-wax casting, and other manufacturing processes.

Within the preferred embodiment of this invention, the apparatus is manufactured using the same machinery and materials as are commonly used to manufacture other door hardware and fenestration hardware and accessories.

Once manufactured, the apparatus of this invention can be easily stacked, packaged, transported and stored using a very small amount of space. Consequently, the invention minimizes the packaging size and cargo space required to contain, transport and stock the apparatus. This in turn, reduces transportation, storage and stocking costs.

Furthermore, the overall “one-size-fits-all” type of structure that can be used within this invention eliminates the need to manufacture a wide assortment of differently sized apparatus. In turn, suppliers and retailers are not required to warehouse, stock, sort and replenish a wide assortment of differently sized apparatus.

The apparatus as taught herein is simple and easy to construct, install, use and remove. Only a minimum amount of manipulation, physical dexterity, skill, knowledge and/or effort are required to construct, assemble and use the apparatus and the processes of this invention.

The apparatus of this invention can be easily secured, removed and transferred to different door frames and/or window frames with only a minimum amount of delay, work, difficulty or trouble.

If properly installed and used, when removed from a particular door frame, the apparatus of this invention will not leave behind a marred surface upon either the door, the door frame, the door jamb, the window, the window frame, the window jamb and/or the associated molding. Consequently, this invention can be removed and taken with the user as the user moves to successive apartments, dwellings, homes, offices or locations without leaving any damage or apparent evidence of use.

In essence, this invention can be reused over and over again by one or more tenants or homeowners for long periods of time. Unless there is a dramatic change in the structure of standard door and window hardware, this invention can be used for an indefinite period of time, i.e., for decades or even longer.

Alternatively, the apparatus of this invention may be manufactured for a single use on a particular door frame or window frame and then be disposed of, recycled or thrown away in the garbage when its use is no longer needed. Within the preferred embodiment of this invention, the apparatus is manufactured from metal which can and should be recycled if and when the invention is no longer needed.

This invention does not require a large number of different, complex accessories or attachments to be used therewith. Rather, the simplicity of this invention invites its repetitive and continued use, thereby saving the financial resources of the building owner, user and world ecology.

The simplicity of this invention need not distract from the door or window design or from the appearance of the surroundings door or window jamb, molding, walls and decorations. In other words, this invention preferably is subtle in shape, configuration and appearance and need not necessarily draw attention to itself.

Alternatively, this invention may be specifically designed to draw attention to itself and be used as a fashion statement, or as a marketing and/or promotional item or object. For example, this invention may be used to draw the attention of observers to indicia that is printed upon, applied to or written on the apparatus of this invention. To accomplish this task, the apparatus of this invention may be constructed to have a readily visible surface upon which a message or indicia may be printed, adhered and/or written. The message or indicia borne by the apparatus may include: instructional information for purposes of installation and/or use of the invention; the manufacture's trademarks; advertising indicia, such as the name of a particular manufacturer and/or vendor; the manufacturer's street address, telephone number and/or Internet website address; the product part or model number; and the like.

The apparatus of this invention can be manufactured with unique and distinctive shapes and configurations that have nonfunctional and nonutilitarian features therein which serve to indicate a particular source of origin and endear such products to consumers and potential consumers. It is anticipated that consumers and the public at large will begin to associate feelings of security, peace of mind and comfort with the new, unique and distinctive shapes and configurations of the various forms of the apparatus of this invention.

It is also anticipated that consumers and potential consumers will come to recognize and associate the brand names and the shapes and/or configurations of this invention as trademarks and trade dress of a particular manufacturer or vendor, thereby, increasing consumer and public recognition and goodwill associated therewith. It is believed that such distinctive shapes, configurations, marks, trade dress, trademarks and brand names which will be used with the apparatus of this invention will become extremely valuable assets.

It is anticipated that the cost to manufacture this invention and supply it with relatively long, strong screws that will reach into the door jamb studs or window casements will be relatively negligible in comparison to the wholesale and retail selling price of this invention. The increased security provided by this invention, however, will have both an actual and a perceived greater value added. Consequently, it is believed that this invention could be sold to consumers for a significantly higher sales price than the cost of manufacture, packaging and distribution.

If desired, security screws may be used to prevent a would-be intruder from removing or replacing the screws from he strike plate and invention when the door or window is in an open position. Such security screws permit the screw to be firmly inserted into the jamb but there is no purchase within the screw head to permit the screw to be reversed or removed. Such purchase is either ground down or the screw head is manufactured to not include a removal purchase thereon. In other words, such security screws can only turn one way.

It is anticipated that the profit margin for the sale or this apparatus will be significantly higher for the manufacturers, wholesalers and retailers handling this invention than would be found by selling many other door hardware and fenestration products. Such increased profit margins should make this invention very desirable for wholesalers and retailers to promote and sell with their other door and window hardware.

It is further anticipated that the increase in sales or such apparatus will dramatically overshadow the minimal cost to manufacture, package and distribute the apparatus of this invention.

This invention may further be constructed to: (a) permit selectively bar the door or window in its fully closed position; (b) prevent unwanted entry by persons on the opposite side of the door or window; (c) prevent the barrier or stop element from being manipulated and removed by someone on the other side or opposite side of the door or window; (d) prevent inadvertent, undesired and/or accidental movement of the barrier from its unlocked position to a position that bars the door or window in a closed position; and (e) selectively permit the barrier to prevent the door or window to be inadvertently or accidentally closed.

Please be aware that use of alternative terms throughout this disclosure should be considered as synonyms of one another and not exclusive of one another. In other words, if a list of alternative terms or words are used within this disclosure and/or within the appended Claims, use of any of such terms or words may encompass one or more or even all of the other alternative terms, as well and all terms and words covered under the Doctrine Of Equivalents. This concept applies to all alternative terms used throughout this disclosure.

Within the preferred embodiment, the apparatus of this invention is used with a strike or striker plate. The strike plate has a bolt opening, latch bore, cutout, receptacle or indentation into which a traditional spring biased latch bolt and/or dead bolt of a door latch may be received. The strike plate may have a leading edge which extends partially outward into the room from the door jamb. The leading edge of the strike plate may be slightly bent or angled to provide a ramp that directs the spring biased latch bolt into the bolt opening.

The strike plate also has one or more holes therein through which one or more strike plate screws may be inserted to secure the strike plate to the jamb and/or to the internal upright studs positioned within the adjacent wall.

Please note that there can be numerous different sizes of door lock sets and associated strike plates. More particularly, the spacing or distance between the screw holes in such several strike plates can vary dramatically between different manufacturers and door lock designs. Consequently, in order to prevent the need to stockpile a myriad of differently sized apparatus for inventory, it is preferable that one size of the apparatus of this invention fit all different strike plate designs and sizes.

More particularly, portions of this invention are constructed of a relatively thin piece of metal, wire, cable, graphite, plastic, fabric, composite material or other rather durable material which defines a first bracket. The first bracket is provided with a first hole, aperture or loop at a proximal end thereof. The first bracket is also provided with a second hole, aperture or loop therein through or into which at least a portion of the barrier or stop element may be selectively inserted and retained to selectively and removably engage the bracket and bar movement of the door or the window when engaged. Such second hole is generally positioned near a distal end of the first bracket.

To better understand the installation and operation of this invention, imagine for a moment that the strike plate of the door or window is removed. The thin piece of material that forms the first bracket is juxtaposed against the jamb so that the first hole near the proximal end thereof is superimposed upon one or more of the holes otherwise used to secure the strike plate to the door frame or window frame. At this point, the strike plate screw or screws are not yet inserted into the hole. Rather, the strike plate is placed over top of the thin piece of material or first bracket. In other words, the first bracket is juxtaposed between the strike plate and the jamb. The strike plate screws or replacement screws are then inserted through the holes in the strike plate, through one or more of the first holes in the first bracket, and into the jamb using the same holes in the jamb that were originally used to secure the strike plate to the jamb. Thus installed, one or more of the screws pass through at least one hole in the proximal end of the thin piece of material which defined the first bracket.

Notwithstanding the foregoing, in connection with appropriate embodiments of the invention, it is possible to supply a replacement strike plate with the inventive apparatus that attaches to the jamb by using new holes. This allows the replacement strike plate to be attached without using the holes that were used to attach the original strike plate. Not only does this allow the use of previously unused material in the jamb, but it also allows the strike plate to be attached using more fasteners. For example, where an original rectangular strike plate attaches to the jamb by means of two screws (one above the bolt hole and one below the bolt hole), a replacement strike plate can provide for attachment to the jamb by means of four screws, one in each of the four corners of a rectangular replacement strike plate.

Please note that during this process, the thin piece of material or first bracket is oriented to protrude outwardly into the room from behind the strike plate and, if desired, can be manipulated and/or bent. For example, a portion of the first bracket is generally coplanar with, parallel to, or slightly offset from the jamb and strike plate. When the door or window is closed within the frame or jamb, the aforesaid outward extension or distal end of the first bracket, which is positioned adjacent and very near to the front, leading or outward upright edge of the door or windows, is bent approximately 90 degrees to assume a generally horizontal orientation on the distal end thereof.

More particularly, the distal end of the first bracket extends into the room past the jamb and door or window. As explained above, the distal end of the first bracket is provided with at least one aperture, hole, slot or loop through which or into which at least a portion of a barrier or stop element may be selectively inserted to at least partially block or limit the pivotal movement of the door or window relative to the strike plate when the door or window is in a closed position and the barrier or stop element properly engages the first bracket. In other words, the barrier or stop element may be selectively inserted into the second hole or aperture in the first bracket to provide means for securing the door or window in a closed position.

The barrier or stop element generally defines a barrier support which has at least a portion thereof that extends from near the jamb into the otherwise path of the door or window when the door or window is about to open. Thus positioned, the barrier or stop element selectively limits or blocks the pivotal movement of the door or window from its initially closed position. When thus positioned, the barrier effectively prevents the door or window from being opened. Even if a handle latch of the door or window is unlocked, appropriate engagement of such rigid object, barrier or stop element is an effective means for preventing the unwanted opening of the door or window.

By way of example and not limitation, the barrier or stop element may comprise an insertable rod, bolt, nail, pin or bar; carabineer; clip; spring-loaded clip; snap; snap shackle; shackle; hook; piton; a screwdriver; keyed padlock; combination padlock or nearly any other generally rigid, solid or semi-rigid object that accomplishes the intended objective of selectively and removably engaging the first bracket to prevent the door or window from opening.

Within the preferred embodiment of this invention, the barrier or stop element generally comprises a T-shaped rod, pin or object having a generally vertical insertion member and a generally horizontal bar member. The insertion member may be selectively inserted into the second hole within the first bracket and be held in place by gravity, a frictional fit and/or by mechanical means, such as by the use of a pivoting stop member, bifurcated feet or resilient springs attached thereto or incorporated therein.

As the door or window is urged against a first side of the horizontal bar member, the horizontal bar member pivots about a longitudinal axis of the vertical insertion member. This in turn urges a second side of the horizontal bar member into the adjacent jamb, frame or wall, thus barring further movement of the door or window.

In essence, an internal sidewall of the second hole located within the first bracket serves as a fulcrum. The force or energy exerted against the door or window in an attempt to open the door or window is directed against the barrier or stop element, is transmitted through the first bracket, through the screws securing the strike plate and first bracket to the jamb, and subsequently into the jamb and corresponding internal upright studs that in part form the doorway or window opening.

Since the screws are inserted and positioned generally perpendicularly or transversely to the direction of force or pull, this invention permits substantially the full shear strength of the strike plate screws, bolts, nails or welds to be used to prevent the opening of the door or window. Such full shear strength is available because such screws, bolts, nails or welds are placed in shear with all or nearly all forces being tangential or perpendicular to the longitudinal length of the screws, bolts or nails, rather than being simply pulled longitudinally out of the jamb.

If desired, more than one hole may be provided within the proximal end of the first bracket to accommodate easy passage of one or more screws therethrough. Using a plurality of holes near the proximal end of the first bracket provides a variety of positions through which the screw may pass. By varying through which hole in the proximal end of the first bracket the screw is passed, the position of the distal end and the second hole therein, relative to the wall and jamb, may be adjusted.

Thus far, this discussion has been limited to the use of a single first bracket. However, the strength of this invention would be enhanced if two or more brackets were used. For convenience in description, reference will be made to the first bracket described above and to a second bracket placed in a spaced manner therebelow. In other words, this invention may include both a first bracket and a second bracket. The second bracket is positioned in a similar manner as the first bracket. For example, a first screw, nail, pin, rivets weld, etc., could be used to secure the strike plate and the first bracket in place against the frame and/or jamb. A second screw, nail, pin, rivet, weld, etc., could similarly be used to further secure the strike plate and the second bracket in place against the frame and/or jamb.

The second bracket has a second proximal end and a second distal end. The second proximal end may have one or more holes, apertures, loops or orifices therein through which the second screw, nail, pin, rivet or weld is passed. The second distal end is also provided with at least one hole, aperture, loop or orifice therein, through which the generally vertical insertion member may be inserted and selectively retained.

Within the preferred embodiment of this invention, a single barrier or stop element is used and the generally vertical insertion member passes through both the hole located within the distal end of the first bracket and the hole located within the distal end of the second bracket. Thus position, the barrier or stop element is prevented from tipping or rotating about the first bracket.

Alternatively, the invention may include a first barrier or stop element which is selectively inserted into the hole within and near the distal end of the first bracket, and a second barrier or stop element which is selectively inserted into the hole within and near the distal end of the second bracket.

As suggested above, in order to prevent the barrier or stop element from becoming dislodged, the barrier may be provided with bifurcated feet which further urge the barrier into proper alignment and tight engagement with the first bracket and/or the second bracket. The bifurcated feet are intended to engage the first and/or the second bracket and prevent the barrier from becoming inadvertently detached therefrom.

Within an alternative embodiment of this invention, the lowermost or distal end of the barrier or stop element may be provided with on or more protrusions that can be pinched together, but which expand outwardly when such pressure is released. Again, such protrusions or pinchable segments are intended to engage the first bracket and/or the second bracket and prevent the barrier from becoming inadvertently detached therefrom.

When a user or occupant desires to bar the door or window in a closed position and prevent its opening, the generally vertical portion of the barrier or stop element is passed or slid downwardly through the aligned, collinear holes or apertures located within the outwardly extending first distal end of the first bracket and/or the second distal end of the second bracket. The cantilevered portion of the upper crossbar member of the barrier or stop element passes beyond the edge of the door or window, thereby, protruding into the otherwise path of the door or window. Thus positioned, the barrier or stop element prevents the door or window from being opened.

When the user or occupant desires to open the door or window, the barrier or stop element is simply removed from its engagement with the first and/or second brackets.

In other embodiments, the present invention can take the general form of a vertically oriented cylindrical shell attached to, or integrally a part of a replacement, strike plate. The cylindrical shell can have a triangular cross-section. The vertically oriented cylindrical shell encloses a circular cylindrical rod whose upper end provides attachment to an S-shaped rod and whose lower end provides means to prevent the rod from being removed from the cylindrical shell. The S-shaped rod has an upper horizontal portion and central vertical portion and a lower horizontal portion. The upper edges of the cylindrical shell has semi-circular indentations that are oriented to receive the upper horizontal portion of the S-shaped rod in either an engaged or a disengaged position. The S-shaped rod is rotatable from the engaged position to the disengaged position, or vice versa.

In a related embodiment, the cylindrical shell can have a slot or groove formed in a portion of its side to guide the vertical and rotational positions of the cylindrical rod by means of a projection formed or placed in the cylindrical rod. By this means, the cylindrical rod can be caused to move between the engaged and disengaged positions.

In still another related embodiment, the upper end of the cylindrical rod can have an engagement surface that engages the door or window when the cylindrical rod is turned to the engaged position. The projection can include a U-shaped portion that forces the engagement surface into its engaged position. The engagement surface can also be supported from the cylindrical rod without having the U-shaped portion. To facilitate efficiency in the manufacturing process, another embodiment of the invention can have two engagement surfaces, one facing toward the door or window in the engaged position and the other facing away from the door or window in the engaged position. In this embodiment, the upper portion of the cylindrical shell can be U-shaped to retain the projection that supports the two engagement surfaces, preventing the projection from rotating when the cylindrical rod is in the engaged position. The cylindrical rod can be retained in the engaged position by means of outwardly-biased springs that spring outwardly into notches that are formed in the U-shaped portion of the cylindrical shell. Another form of this embodiment allows another U-shaped portion at the bottom of the cylindrical shell, so that the invention can be used in either the left- or right-handed orientation.

While normally the cylindrical rod will be retained in a downward, engaged position by the force of gravity, it can also be aided by means of a biasing element such as a coil spring placed around the lower portion of the cylindrical rod when the invention is assembled.

In yet another embodiment, the invention can take the form of a length of chain, cord, or such like, having a number of loops formed therein. One end of the chain, cord, or such like is attached to an L-shaped rod that slides vertically into the cylindrical shell. The L-shaped rod can be passed through one of the loops to form a larger loop that can be placed around a projection from the door or window, such as a door knob or a closure handle. In use, this embodiment is placed around the projection and the L-shaped rod is then placed into the cylindrical shell.

The L-shaped rod can be retained in the cylindrical shell by various means. In one embodiment, outwardly-biased springs placed near the lower end of the L-shaped rod allow the L-shaped rod to be placed into the cylindrical shell, but must be affirmatively squeezed against the L-shaped rod to allow the L-shaped rod to be pass upwardly through the cylindrical shell. In another embodiment, a toggle near the lower end of the L-shaped rod can be aligned with the lower portion of the L-shaped rod to allow the L-shaped rod to be placed into the cylindrical shell. After passage through the cylindrical shell, the toggle turns Across-wise to the lower portion of the L-shaped rod to prevent the L-shaped rod to pass upwardly through the cylindrical shell unless the toggle is again brought into alignment with the lower portion of the L-shaped rod.

In connection with embodiments that rely on the integrity of the strike plate, a plate that covers the strike plate to prevent the strike plate from being detached when the door or window is partially open. Furthermore, the strike plate can be attached to the jamb by means of a first set of screws that are farther from the interior of the room and a second set of screws that are closer to the interior of the room. Since the second set of screws are generally inaccessible from outside the room, while the first set of screws are accessible, the screws in the first set of screws can be larger and longer than the screws in the second set of screws, while the screws in the second set can have a finer thread pitch.

It may be important to prevent the S-shaped rod from rotating significantly above horizontal. This prevents the S-shaped rod from inadvertently moving from the disengaged position to the engaged position by being left upwardly against the door or window jamb. It also prevents a prankster from engaging the S-shaped rod from outside the door or window by leaving the S-shaped rod above the horizontal position when exiting the room and then causing the S-shaped rod to fall down to the engaged position by means of a loop of string or wire.

The preferred and several alternative embodiments of the apparatus and associated structures of this invention, and the processes for manufacture and use thereof, are further described in greater detail within the following description, Claims and drawings of this Specification. However, to avoid any possible confusion as to the scope of the current invention, each of the following sections, claim language and the drawings of this Specification in their entirety are incorporated within this portion of the Specification by this reference.

In addition to the above-identified benefits and advantages of this invention, this invention also overcomes all or nearly all of the aforementioned disadvantages and shortcomings of the devices heretofore known in the applicable art.

According to a first aspect, the invention is an apparatus for selectively barring or securing a hinged door or window against being pivoted from a closed or partially closed position to an open position. The door or window has at least one hinge and has a latch bolt or dead bolt adapted to operatively secure the door or window to a jamb when in the closed position. The jamb has a strike plate capable of being secured or mounted to the jamb generally adjacent to the latch bolt or dead bolt when the door or window is in the closed position. The strike plate has a bolt hole, aperture or recess into which a portion of the latch bolt or dead bolt may be received. The strike plate has at least one hole or aperture through which a screw, bolt, nail, pin, rivet or weld may pass to secure or mount the strike plate to the jamb.

The apparatus includes an elongated first bracket and a barrier or stop element. The elongated first bracket has a proximal end and an opposed distal end. The first bracket has at least one strike plate hole, aperture, loop, orifice or slot positioned near said proximal end thereof through or into which at least a portion of the screw, bolt, nail, pin, rivet or weld is capable of passing to secure the proximal end of the first bracket to the jamb. At least a portion of the distal end of the first bracket extends outwardly away from the jamb and the strike plate. The barrier or stop element is capable of selectively and removably engaging the first bracket near the distal end thereof to at least partially block pivotal movement of the door or window relative to the strike plate when the door or window is in the closed or partially closed position and the barrier or stop element operatively engages the first bracket.

According to a second aspect, the invention is a method for selectively barring or securing a hinged door or window against being pivoted from a closed or partially closed position to an open position. The door or window has at least one hinge and has a latch bolt or dead bolt adapted to operatively secure the door or window to a jamb when in the closed position. The jamb has a strike plate capable of being secured or mounted to the jamb generally adjacent to the latch bolt or dead bolt when the door or window is in the closed position. The strike plate has a bolt hole, aperture or recess into which a portion of the latch bolt or dead bolt may be received. The strike plate has at least one hole or aperture through which a screw, bolt, nail, pin, rivet or weld may pass to secure or mount the strike plate to the jamb.

The method includes the steps of (a) connecting an elongated first bracket to the jamb, and (b) selectively and removably engaging a barrier or stop element to said first bracket. The elongated first bracket has a proximal end and an opposed distal end. The first bracket has at least one strike plate hole, aperture, loop, orifice or slot positioned near the proximal end thereof through or into which at least a portion of the screw, bolt, nail, pin, rivet or weld is capable of passing to secure the proximal end of the first bracket to the jamb. At least a portion of the distal end of the first bracket extends outwardly away from the jamb and the strike plate. The barrier or stop element is selectively and removably engaged to the first bracket near the distal end thereof to at least partially block pivotal movement of the door or window relative to the strike plate when the door or window is in the closed or partially closed position. The barrier or stop element operatively engages the first bracket.

According to a third aspect, the invention is an apparatus for selectively barring or securing a hinged door or window against being pivoted from a closed or partially closed position to an open position. The door or window has at least one hinge and has a latch bolt or dead bolt adapted to operatively secure the door or window to a jamb when in the closed position. The jamb has a strike plate capable of being secured or mounted to the jamb generally adjacent to the latch bolt or dead bolt when the door or window is in the closed position. The strike plate has a bolt hole, aperture or recess into which a portion of the latch bolt or dead bolt may be received. The strike plate has at least one hole or aperture through which a screw, bolt, nail, pin, rivet or weld may pass to secure or mount the strike plate to the jamb.

The apparatus includes means for connecting an elongated first bracket having a proximal end and an opposed distal end to the jamb and means for selectively and removably engaging a barrier or stop element to the first bracket near the distal end thereof. The first bracket has at least one strike plate hole, aperture, loop, orifice or slot positioned near the proximal end thereof through or into which at least a portion of the screw, bolt, nail, pin, rivet or weld is capable of passing to secure the proximal end of the first bracket to the jamb. At least a portion of the distal end of the first bracket extends outwardly away from the jamb and the strike plate. The means for selectively and removably engaging at least partially blocks pivotal movement of the door or window relative to the strike plate when the door or window is in the closed or partially closed position. The barrier or stop element operatively engages the first bracket.

The foregoing and other objectives and advantages of this invention will become more readily apparent upon reading the following disclosure and referring to the attached drawings.

### BRIEF DESCRIPTION OF DRAWINGS

FIG. 1 is a schematic and perspective view of a first embodiment of the apparatus of this invention as built in accordance with the teachings of this patent disclosure. FIG. 1 illustrates the door or window in a locked position by the attachment of the barrier or locking means selectively and removably secured to the first bracket and to the second bracket. The barrier or locking means is illustrated as comprising an downwardly projecting elongated bar that operatively engages and is removably retained by the first bracket and by the second bracket and has a generally horizontal or perpendicular cross-member at an uppermost or proximal end thereof that is capable of engaging the door or window and the jamb. More particularly, the barrier or stop element is inserted generally vertically into a hole or aperture located within the first bracket and/or within the second bracket,

FIG. 2 is an enlarged, partial, schematic and perspective view of the first embodiment of the apparatus of this invention, as illustrated within FIG. 1, illustrating the selected insertion or removal of the barrier or stop element from engagement with the first bracket and with the second bracket. More particularly, FIG. 2 illustrates how the barrier or stop element can be selectively and removably moved relative to the strike plate and jamb from a lower engaged position to a raised, retracted and disengaged position. When in its lowered engaged position, the barrier or stop element is retained within barrier holes located within the distal ends of the first bracket and/or second bracket. The barrier or stop element is retained in this position by the force of gravity and a relatively tight engagement or frictional fit with the first and/or second brackets until removed therefrom. When in its raised disengaged position, the barrier or stop element can be removed out of the path of the opening door and stored for later use. The barrier or stop element may be tethered to the door knob or to the jamb by a string, rope, chain, chord, linkage, wire or the like when not in use.

FIG. 3 is an enlarged, partial, schematic and perspective view of the first embodiment illustrated within FIG. 1 and 2 with the door or the window swung open to better reveal the structure of the strike plate, the first bracket and the second bracket. FIG. 3 illustrates the first bracket and the second bracket juxtaposed between and secured to a strike plate and a jamb. The first bracket and second bracket are held in place with the same screws, bolts, nails or welds that hold the strike plate in place on the jamb. Please note that the distal ends of the generally planar material of the first bracket and of the second bracket are each bent or rotated about ninety degrees (90°) from vertical so that the elongated distal end of the barrier or stop element may be inserted generally vertically into the corresponding hole located within the first bracket and/or second bracket, and, thereby, permit engagement and retention of the barrier or stop element therein.

FIG. 4 is an enlarged, partial, exploded, schematic and perspective view of the first embodiment illustrated within FIGS. 1, 2 and 3 with the door or the window swung open to better reveal the structure, placement and orientation of the strike plate, the first bracket and the second bracket relative to the jamb. FIG. 4 illustrates the first bracket and the second bracket positioned between the strike plate and the jamb. The same screws, bolts, nails or welds that hold and secure the strike plate in place also hold and secure the first bracket and the second bracket in place against the jamb. The first bracket and the second bracket comprise elongated lengths of metal segments or ribbon that are bent near a distal end or at a midportion thereof.

FIG. 5 is an enlarged, cross-sectional, plan view of the barrier or stop element in its locked position within the first barrier and second barrier, as seen along a plane defined by line V-V in FIG. 1.

FIG. 6 is an enlarged, cross-sectional, plan view of the barrier or stop element shown in FIG. 5 with the door or window attempted to be opened and the barrier pivoting within the first barrier and the second barrier and preventing the door or window from being opened.

FIG. 7 is an enlarged, schematic and elevational view of a second alternative barrier or stop element having a pivotal member positioned within a distal end thereof.

FIG. 8 is an enlarged, schematic and elevational view of a third alternative barrier or stop element having flexible, expandable protrusions or feet within a distal end thereof.

FIG. 9 is an enlarged, schematic and elevational view of a fourth alternative barrier or stop element having flexible, expandable bifurcated feet within a distal end thereof.

FIG. 10 is an enlarged, partial, schematic and perspective view of a second embodiment of the apparatus of this invention wherein the first bracket is provided with a first barrier or stop element and the second bracket is provided with a second barrier or stop element. To better reveal the structure of this embodiment of the invention, the figure illustrates the door or the window swung to an open position. FIG. 10 also illustrates the first barrier or stop element and the second barrier or stop element in a position that selectively and temporarily bars the door or window in an open position. This position may be used in a hotel and/or motel to keep the door open while the occupant moves the luggage into the room. Alternatively, this position may be used by housecleaning personnel while cleaning, restocking and preparing the room for a new occupant.

FIG. 11 is a perspective view of a third embodiment of the apparatus of this invention, showing the apparatus in its engaged position in dashed lines. FIG. 11 also shows upward movement of the apparatus from the engaged position.

FIG. 12 is a perspective view of the third embodiment of the apparatus of this invention, showing the apparatus in its unengaged position. FIG. 12 also shows rotational movement of the apparatus toward the unengaged position and downward movement of the apparatus into the unengaged position.

FIG. 13 is a perspective view of a fourth embodiment of the apparatus of this invention, showing the apparatus in a partially engaged position.

FIG. 14 is a perspective view of the fourth embodiment of the apparatus of this invention, showing the apparatus in its fully engaged position. FIG. 14 also shows rotational movement of the apparatus toward the fully engaged position and rotational movement of the barrier or stopping element of the apparatus when the door or window is in a partially open position.

FIG. 15 is a perspective view of a fifth embodiment of the apparatus of this invention.

FIG. 16 is a side view of the fifth embodiment of the apparatus of this invention, showing the loop being formed into a larger loop.

FIG. 17 is a perspective view of the fifth embodiment of the apparatus of this invention, showing the larger loop engaged with a door.

FIG. 18 is a perspective view of a sixth embodiment of the apparatus of this invention.

FIG. 19 is a perspective view of a seventh embodiment of the apparatus of this invention.

FIG. 20 is a perspective view of an eighth embodiment of the apparatus of this invention.

FIG. 21 is a side view of the eighth embodiment of the apparatus of this invention, showing the transition of the toggle from an insertion position to an engaged position.

FIG. 22 is a perspective view of a ninth embodiment of the apparatus of this invention.

FIG. 23 is a side view of the ninth embodiment of the apparatus of this invention, showing alternative positions of the S-bar in dashed lines.

FIG. 24 is a perspective view of a tenth embodiment of the apparatus of this invention, showing the various fasteners used in connection with the tenth embodiment and a tool used to align the strike plate of the tenth embodiment.

FIG. 25 is a top view of an eleventh embodiment of the apparatus of this invention, showing angular rotation of the is cylindrical rod within the cylindrical shell of the invention.

FIG. 26 is a perspective view of the left side of the eleventh embodiment of the apparatus of this invention, showing constrained vertical and rotational movement of the cylindrical rod within the cylindrical shell of the invention.

FIG. 26A is a perspective view of the right side of the eleventh embodiment of the apparatus of this invention.

FIG. 27 is a perspective view of the left side of the eleventh embodiment of the apparatus of this invention, showing the cylindrical rod nearly fully engaged within the cylindrical shell of the invention, and the possible rotational movement of the S-bar of the invention.

FIG. 28 is a perspective view of the left side of the eleventh embodiment of the apparatus of this invention, showing the cylindrical rod fully engaged within the cylindrical shell of the invention.

FIG. 29 is a perspective view of a twelfth embodiment of the apparatus of this invention, showing the apparatus in the engaged position.

FIG. 30 is a top view of the twelfth embodiment of the apparatus of this invention, showing angular rotation of the cylindrical rod within the cylindrical shell of the invention.

FIG. 31 is a perspective view of a thirteenth embodiment of the apparatus of this invention, showing the apparatus in the engaged position.

FIG. 32 is a perspective view of the thirteenth embodiment of the apparatus of this invention, showing the movements of the apparatus to move the apparatus to the unengaged position.

FIG. 33 is a perspective view of a tool for installation of various embodiments of the invention.

FIG. 34 is a perspective view of the results of using the tool of FIG. 33.

FIG. 35 is an exploded perspective view of a fourteenth embodiment of the apparatus of this invention.

FIG. 36 is a perspective view of the fourteenth embodiment of the apparatus of this invention, showing the movements and actions necessary to movement the apparatus to the engaged position and to lock the apparatus in the engaged position.

FIG. 37 is a top view of the fourteenth embodiment of the apparatus of this invention, showing the actions necessary to movement the apparatus to the engaged position and to unlock the apparatus when it is in the engaged position.

FIG. 38 is a phantom perspective view of the fourteenth embodiment of the apparatus of this invention, showing the apparatus in the engaged and locked position with a right hand door.

FIG. 39 is a perspective view of the fourteenth embodiment of the apparatus of this invention, showing the apparatus in the engaged and locked position with a left hand door.

FIG. 40 is a perspective view of the fifteenth embodiment of the apparatus of this invention.

FIG. 41 is a side view of the fifteenth embodiment of the apparatus of this invention.

FIG. 42 is a perspective view of the sixteenth embodiment of the apparatus of this invention.

FIG. 43 is a first side view of the sixteenth embodiment of the apparatus of this invention.

FIG. 44 is a first elevation view of the sixteenth embodiment of the apparatus of this invention.

FIG. 45 is a second side view of the sixteenth embodiment of the apparatus of this invention.

FIG. 46 is a second elevation view of the sixteenth embodiment of the apparatus of this invention.

FIG. 47 is a third side view of the sixteenth embodiment of the apparatus of this invention.

FIG. 48 is a third elevation view of the sixteenth embodiment of the apparatus of this invention.

FIG. 49 is a first perspective view of the seventeenth embodiment of the apparatus of this invention showing my new design in a disengaged position;

FIG. 50 is a front -view of the seventeenth embodiment of the apparatus of this invention showing my new design in the disengaged position;

FIG. 51 is a rear view of the seventeenth embodiment of the apparatus of this invention showing my new design in the disengaged position;

FIG. 52 is a left side elevational view of the seventeenth embodiment of the apparatus of this invention showing my new design in the disengaged position;

FIG. 53 is a right side elevational view of the seventeenth embodiment of the apparatus of this invention showing my new design in the disengaged position;

FIG. 54 is a top view of the seventeenth embodiment of the apparatus of this invention showing my new design in the disengaged position;

FIG. 55 is a bottom view of the seventeenth embodiment of the apparatus of this invention showing my new design in the disengaged position;

FIG. 56 is a second perspective view of the seventeenth embodiment of the apparatus of this invention showing my new design in an engaged position;

FIG. 57 is a front view of the seventeenth embodiment of the apparatus of this invention showing my new design in the engaged position;

FIG. 58 is a rear view of the seventeenth embodiment of the apparatus of this invention showing my new design in the engaged position;

FIG. 59 is a left side elevational view of the seventeenth embodiment of the apparatus of this invention showing my new design in the engaged position;

FIG. 60 is a right side elevational view of the seventeenth embodiment of the apparatus of this invention showing my new design in the engaged position;

FIG. 61 is a top view of the seventeenth embodiment of the apparatus of this invention showing my new design in the disengaged position; and

FIG. 62 is a bottom view of the seventeenth embodiment of the apparatus of this invention showing my new design in the engaged position.

One should understand that the drawings are not necessarily to scale and the elements are sometimes illustrated by graphic symbols, phantom lines, diagrammatic representations and fragmentary views. In some instances, details may be omitted which are not necessary for an understanding of the current invention or which render other details difficult to perceive.

### BEST MODE FOR CARRYING OUT THE INVENTION

Referring to the attached drawings, where like numerals indicate like parts, this invention provides additional, alternative and improved apparatus 20 and processes for selectively barring, locking or securing one or more hinged doors 22 and/or windows 24 in a closed or partially closed, secure position. In other words, the apparatus 20 of this invention can be used to at least partially bar, lock and secure a door 22 or window 24 against being pivoted from a closed or partially closed position to an open position. The selective securement of such doors 22 or windows 24 effectively prevents or significantly retards unwanted and unauthorized entry or ingress of intruders through such doors 22 or windows 24, thereby, increasing the safety, confidence and peace of mind of a tenant, resident or user who deploys or uses the apparatus 20 of this invention.

FIG. 1 illustrates the door 22 or window 24 in a closed or partially closed position within a jamb 26. At least one hinge 28 operatively secures the door 22 or window 24 to the jamb 26.

The door 22 or window 24 also has a latch bolt or dead bolt hidden within the door 22 or window 24 which is operatively associated with a knob 29. The knob 29 is positioned on an inward face 30 or surface of the door 22 or window 24. When the door 22 or window 24 assumes the closed position, the latch bolt or dead bolt further secures the door 22 or window 24 to the jamb 26.

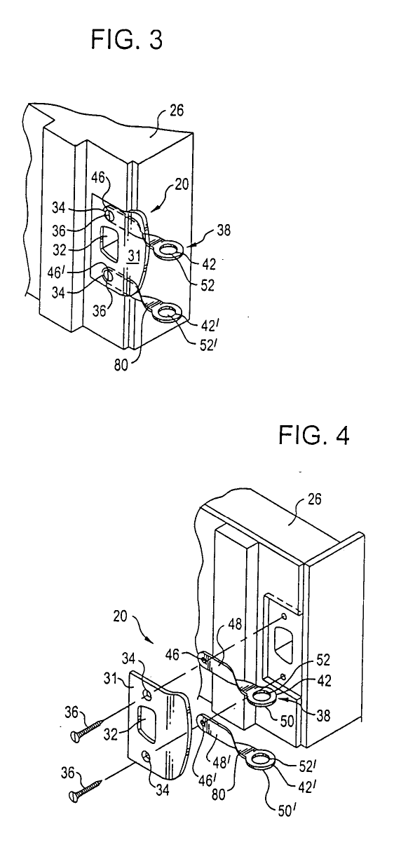

As best seen in FIGS. 3, 4 and 10, the jamb 26 is provided with a strike plate 31. The strike plate 31 is capable of being secured or mounted to the jamb 26 generally adjacent to the latch bolt or dead bolt when the door 22 or window 24 is in the closed position. The strike plate 31 has a bolt hole 32, aperture or recess into which a portion of the latch bolt or dead bolt may be received.

The strike plate 31 also has at least one hole or aperture 34 located therein through which a screw 36, bolt, nail, pin, rivet or weld may pass to secure the strike plate 30 to the jamb 26.

The apparatus 20 of this invention comprises a combination of at least a first bracket 38 and means 40 for electively barring the door 22 or window 24 in the closed or partially closed position.

The first bracket 38 must be capable of being secured or attached to the jamb 26. For example, the first bracket 38 may be provided with at least one strike plate hole 46, aperture, loop, orifice or slot therein which permits the first bracket 38 to be operatively secured to the jamb 26.

Within the preferred embodiment of this invention, the first bracket 38 comprises an elongated length of sheet metal that has a proximal end 48 and an opposed distal end 50. The aforementioned strike plate hole 46 is positioned near the proximal end 48. The strike plate hole 46 is sized and dimensioned to permit at least a portion of the screw 36 to pass therethrough or therein to secure the proximal end 48 of the first bracket 38 to the jamb 26.

The barring means 40 is secured to, attached to or formed integrally with the first bracket 38. For example, the barring means 40 may be at least partially defined by: (a) the first bracket 38 having a barrier support portion 42 therein that extends outwardly into the room from the jamb 26; and (b) a removable barrier 44 which is capable of selectively and removably engaging and retaining the barrier support portion 42. In other words, the barrier support portion 42 has means for selectively holding and retaining the barrier 44.

In terms of the preferred embodiment of this invention, at least a portion of the distal end 50 of the first bracket 38 extends outwardly away from the jamb 26, the strike plate 31 and the face 30 of the door 22 or window 24.

The first bracket 38 has at least one barrier hole 52, aperture, loop, orifice or slot therein which permits the barrier to be operatively secured to the first bracket. More particularly, at least one barrier hole 52 is positioned near the distal end 50 of the first bracket 38. The barrier hole 52 is sized and dimensioned to permit at least a portion of the barrier 44 or stop element to be passed therethrough or thereinto. Thus, the barrier 44 may be inserted into and/or passed through the barrier hole 52 and be retained thereby.

In other words, the barrier 44 or stop element is capable of selectively and removably engaging the first bracket 38 near the distal end 50 thereof to at least partially block the pivotal movement of the door 22 or window 24 relative to the strike plate 31 when the door 22 or window 24 is in the closed or partially closed position and the barrier 44 operatively engages the first bracket 38.

The barrier 44 or stop element comprises a rigid or semi-rigid object which can be quickly and easily removed from engagement with the first bracket 38.

The barrier 44 may comprise a bar 54, bolt, padlock, pin, carabineer, clip,- snap, snap shackle, shackle, hook, piton or screwdriver which is capable of being at least partially inserted into the first barrier hole 52 to at least partially block the pivotal movement of the door 22 or window 24 relative to the strike plate 31 when the door 22 or window 24 is in the closed or partially closed position.

Within the preferred embodiment of this invention, the barrier 44 comprises a generally T-shaped rod, pin or object having a generally horizontal bar member 56 or cross-member and a generally vertical insertion member 58. The insertion member 58 is capable of being selectively inserted into the barrier hole 52 and thereby engaging the first bracket 38 near the distal end 50 thereof.

Once inserted, the barrier 44 is held and retained in place by the forces of gravity, a frictional fit between the sidewalls of the insertion member 58 and the first bracket 38, or by separate or integrated mechanical means.

Within these embodiments of this invention, the generally horizontal bar member 56 of the barrier 44 may serve as a lever or pivotal handle for the apparatus 20. If desired, the generally horizontal bar member 56 may also be weighted to further urge the barrier 44 into tight engagement with the first bracket 38.

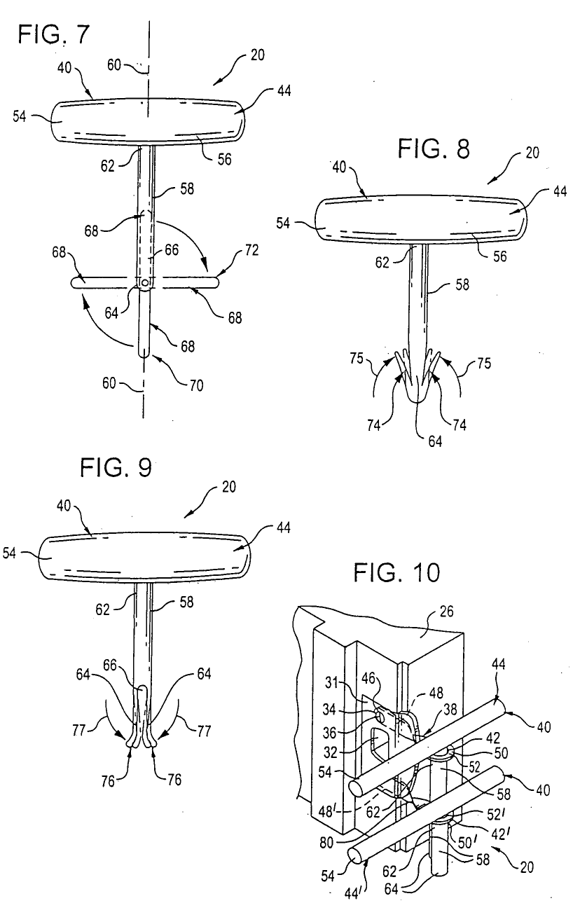

By way of example, the aforementioned mechanical means may comprise at least one pivoting stop member 68 as shown in FIG. 7, one or more bifurcated feet 76 as shown within FIG. 9, and/or one or more resilient springs 74 as shown in FIG. 8, which are operatively attached to or incorporated within barrier 44.

As best seen in FIG. 7, the insertion member 58 may comprise an elongated rod 59 or tube having a longitudinal axis 60 passing therethrough. The insertion member 58 has a proximal end 62 and an opposed distal end 64. The proximal end 62 of the insertion member is attached to the bar member 56. The bar member 56 is generally oriented in a transverse or tangential manner relative to the longitudinal axis 60 of the insertion member 58.

A slot 66 is located within the distal end 64 of the insertion member.,58. The pivotal stop member 68 is rotatably secured to the distal end 64 of the insertion member 58. The stop member 68 is at least partially positioned within the slot 66. The stop member 68 may moved or pivot within a plane that passes through the slot 66 and longitudinal axis 60. In essence, the stop member 68 may move from a first position 70 that is generally collinear with the longitudinal axis 60 to a second position 72 that is generally transverse or tangential to the longitudinal axis 60.

As best seen within FIG. 8, the distal end 64 of the insertion member 58 may be provided with or formed to include one or more resilient springs 74. The sides of springs 74 may be urged toward a central or longitudinal axis 60 of the insertion member as shown by arrows 75 to permit the distal end 64 to pass through the barrier hole 52 within the first bracket 38. Once thus inserted, pressure against the springs 74 may be removed. As a result, the springs 74 deflect outwardly to removably and selectively lock the insertion member 58 to the first bracket 38. When the barrier 44 is to be removed from its engagement with the first bracket 38, the springs 74 may again be compressed and moved through the barrier hole 52 to free the barrier 44 from the first bracket 38.

In a similar manner, as best shown within FIG. 9, the distal end 64 of the insertion member 58 may alternatively be provided with one or more resilient bifurcated feet 76. The resilient bifurcated feet 76 act very similarly to that of the springs 74. The bifurcated feet 76 may be compressed and urged toward the longitudinal axis 60 as indicated by arrows 77 to permit the distal end 64 to be inserted into and removed from the barrier hole 52. However, when such a pressure or compression is removed, the resilient bifurcated feet 76 expand outwardly to securely, selectively and removably retain the barrier 44 within the barrier hole 52.

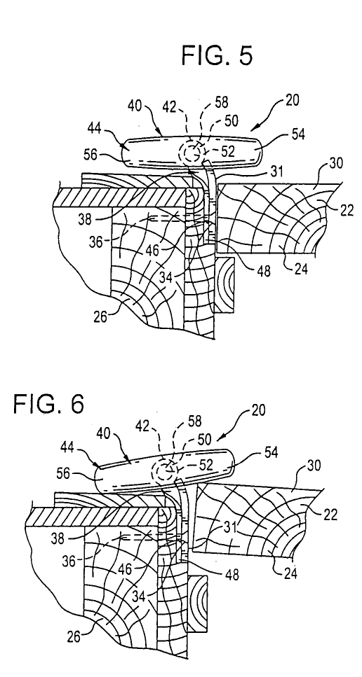

As best seen within FIGS. 5 and 6, when held and retained within the barrier support portion 42, the barrier is generally urged against or near the face 30 of the door 22 or window 24 and the jamb 26.

In essence, the barrier 44 and the first bracket 38 interact with one another and the screws 36 that hold the strike plate 31 to the jamb 26, to at least partially bar or limit pivotal movement of the door 22 or window 24 relative to the jamb 26, when the first bracket 38 is secured to the jamb 26, the door 22 or window 24 is in the closed or partially closed position and the barrier 44 engages the barrier support portion 42. As best seen in FIGS. 5 and 6, the first bracket 38 serves as a fulcrum for the pivotal barrier 44. Forces directed against one side of the horizontal bar member 56 are transmitted through the first bracket 38 into the opposite side of the horizontal bar member 56 and into the jamb 26. Consequently, horizontal bar member 56 is capable of at least partially blocking the pivotal movement of the door 22 or window 24 relative to the strike plate 31 when the door 22 or window 24 is in the closed or partially closed position and the barrier 44 operatively engages the first bracket 38.

FIGS. 1, 2, 5 and 6 clearly illustrate the door 22 or window 24 in a barred or locked position through the use of the apparatus 20.

Thus far within this portion of patent disclosure focus has been restricted to the use of a single bracket, namely the first bracket 38. However, as can be clearly seen within FIGS. 1, 2, 3, 4 and 10, within the preferred embodiment of this invention both a first bracket 38 and a second bracket 80 are used.

The second bracket 80 may also comprise an elongated length of sheet material in nearly an identical manner as was described above for the first bracket 38. For example, the second bracket 80 may also have a proximal end 48′ and an opposed distal end 50′. The second bracket 80 may have at least one strike plate hole 46′, aperture, loop, orifice or slot which is positioned near the proximal end 48′ thereof. At least a portion of one or more screws 36 may be passed through or into the strike plate hole 46′ to secure the proximal end 48′ of the second bracket 80 to the jamb 26. Similarly, at least a portion of the distal end 50′ of the second bracket 80 may extend outwardly away from the jamb 26, the strike plate 31, and the face 30 of the door 22 or window 24.

The barrier 44 may also selectively and removably engage he second bracket 80 near the distal end 50′ thereof in a early identical manner as the barrier 44 engages the first bracket 38. For example, the second bracket may also be provided with at least one barrier hole 52′, aperture, loop, orifice or slot therein. Such barrier hole 52′ is preferably positioned near the distal end 50′ of the second bracket 80. The barrier hole 52′ is sized and dimensioned to permit at least a portion of the barrier 44 to selectively and removably pass therethrough or be inserted therein and be retained therein.

As best seen within FIGS. 3 and 4, the only real difference between the first bracket 38 and the second bracket 80 is that they are secured beneath the strike plate 31 with different and spaced apart screws 36 and 36′.

FIG. 10 illustrates how a first barrier 44 can be inserted and retained within the first bracket 38, and how a second barrier 44′ can be inserted and retained within the second bracket 80.

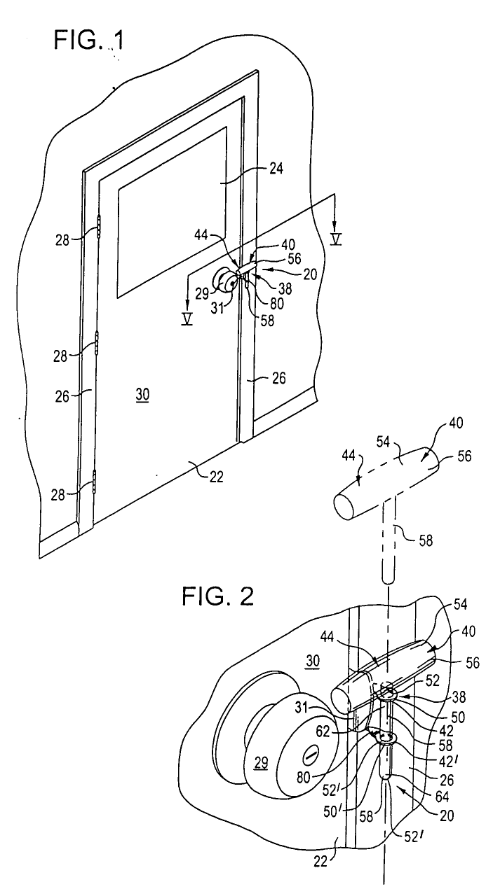

FIGS. 1 and 2 illustrate how a single barrier 44 can be inserted into the barrier holes 52 and 52′ of the first bracket 38 and the second bracket 80, respectively. This embodiment is particularly beneficial because use of both the first bracket 38 and the second bracket 80 provide added stability and rigidity to for the barrier 44. Not only is the cross-sectional surface of the available brackets doubled, but the barrier 44 is held in a more rigid and predictable upright manner, and is prevented from rotating or pivoting about a longitudinal axis of either the first bracket 38 or the second bracket 80.

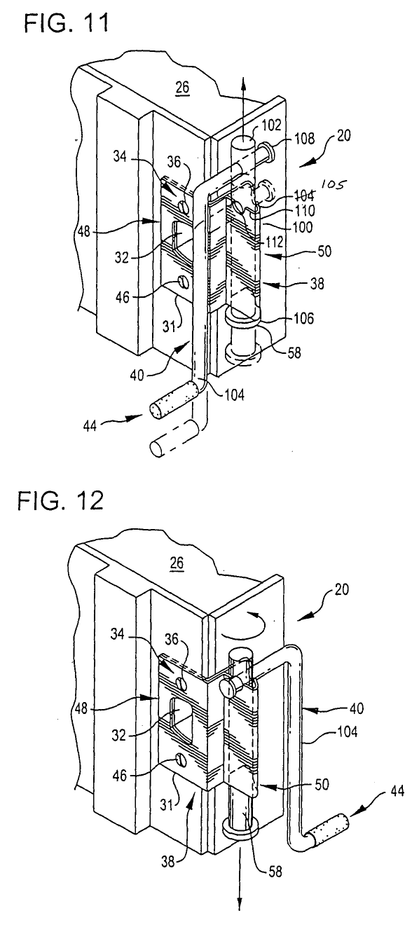

FIG. 11 is a perspective view of a third embodiment of the apparatus of this invention, showing the apparatus in its engaged position in dashed lines. FIG. 11 also shows upward movement of the apparatus from the engaged position. The apparatus 20 is shown as arranged for operation with a right-hand door, i.e., a door that is hinged on the left and opens inwardly.

The apparatus 20 includes a bracket 100, a vertical cylinder 102, and an S-bar 104. The bracket 100 receives the vertical cylinder 102 in a vertical shell 105 that is at an end of the first bracket 38. The upper end of the vertical cylinder 102 extends above the first bracket 38, and the lower end of the vertical cylinder 102 extends below the first bracket 38. The S-bar 104 is made of a metal or other material that is hardened to prevent severing it by means of a saw, torch, bolt-cutter, or the like. The S-bar 104 is attached to the upper end of the vertical cylinder 102 by passing through a hole in the upper end of the vertical cylinder 102. The S-bar 104 has a head 108 on its upper end to prevent the S-bar 104 from disengaging from the vertical cylinder 102. This allows the S-bar 104 to swing about a horizontal axis defined by the hole in the upper end of the vertical cylinder 102. The vertical cylinder 102 rotates about the vertical axis of the vertical shell 105. The lower end of the vertical cylinder 102 includes a head 106 that prevents the vertical cylinder 102 from disengaging from the vertical shell 105 in an upward direction. In the engaged position, the apparatus 20 is rotated to the left, so that the engagement mechanism 44 on the lower end of the S-bar 104 points to the left. The engagement mechanism 44 can include a covering or coating that prevents marring of the door 22. The upper portion of the S-bar 104 is lowered against the upper margins 110 of the vertical cylinder 102. More specifically the upper margins 110 include semi-circular notches 112 which meet the contour of the S-bar 104 to make it difficult for the vertical cylinder 102 to rotate away from the engaged position. The middle portion of the S-bar 104 is parallel to the surface of the door 22 when the door 22 is closed and swings out as far as horizontal with the door 22 when the door 22 is opened.

It can be advantageous for the upper and lower edges of the vertical shell 105 to respectively be tapered downward and upward to reduce or eliminate the chance that the extending vertical shell 105 will catch clothing and the like.

FIG. 12 is a perspective view of the third embodiment of the apparatus of this invention, showing the apparatus in its disengaged position. FIG. 12 also shows rotational movement of the apparatus toward the disengaged position and downward movement of the apparatus into the disengaged position. In the disengaged position the lower end of the S-bar 104 is moved away from the trajectory of the door 22 when it is opened, thus allowing the door 22 to swing fully open. In this configuration, the semi-circular notches 112 which meet the contour of the S-bar 104 make it difficult for the vertical cylinder 102 to rotate away from the disengaged position.

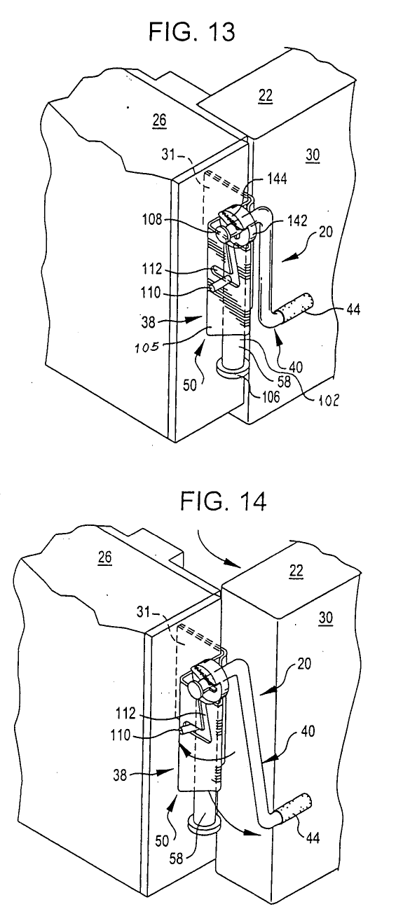

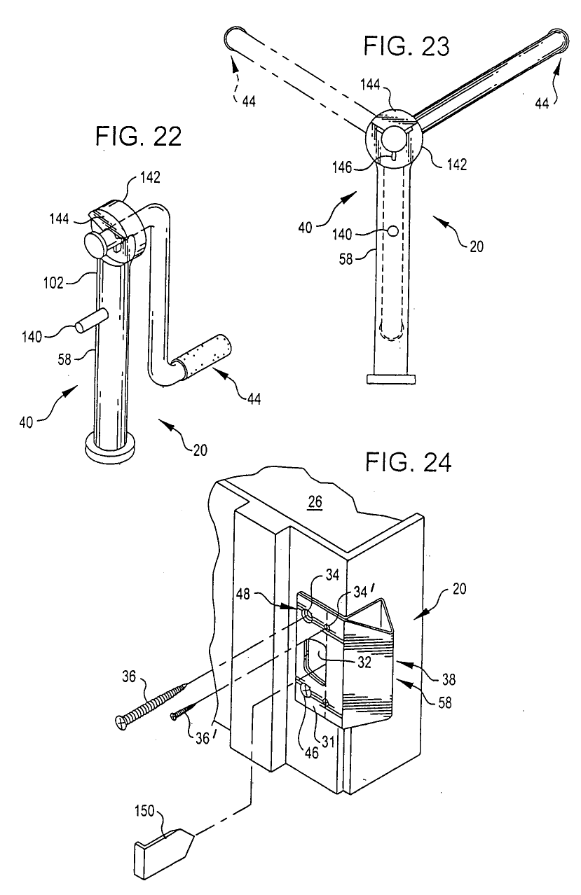

FIG. 13 is a perspective view of a fourth embodiment of the apparatus of this invention, showing the apparatus in a partially engaged position. The apparatus 20 shown in FIG. 13 is a mirror image that shown in FIGS. 11-12 except that the vertical cylinder 102 has a protrusion 110 that extends horizontally outward from the vertical cylinder 102. The protrusion 110 engages a slot 112 that is formed in the vertical shell 105. Initially, the protrusion 110 falls vertically to the bottom of the slot 112, where it stays until the door 22 is pushed open against the engagement mechanism 44 of the lower end of the S-bar 104. When the door 22 is pushed against the lower end of the S-bar 104, the protrusion 110 moves horizontally to the lower end of the slot 112. The details of the upper end of the vertical cylinder 102 are provided in the discussion of FIGS. 22 and 23.

FIG. 14 is a perspective view of the fourth embodiment of the apparatus of this invention, showing the apparatus in its fully engaged position. FIG. 14 also shows rotational movement of the apparatus toward the fully engaged position and rotational movement of the barrier or stopping element of the apparatus when the door or window is in a partially open position. When the door 22 is pushed against the lower end of the S-bar 104, the protrusion 110 moves horizontally to the lower end of the slot 112.

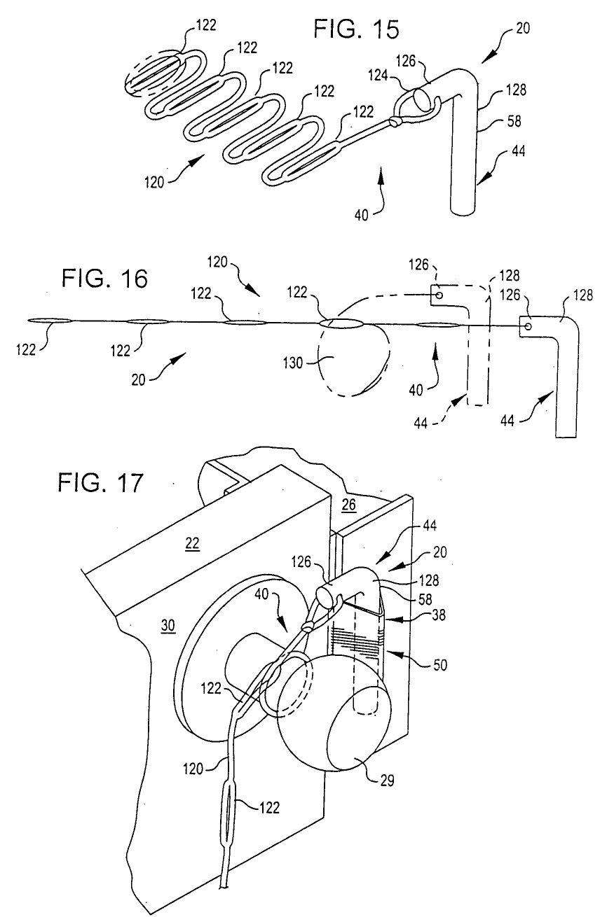

FIG. 15 is a perspective view of a fifth embodiment of the apparatus of this invention. In this embodiment, the apparatus 20 includes a cable 120 (or other thin flexible string-like element). The cable 120 includes two or more loops 122 and an end 124 which is tied through an end 126 in an L-bar 128.

FIG. 16 is a side view of the fifth embodiment of the apparatus of this invention, showing the loop being formed into a larger loop. The larger loop 130 is formed when the L-bar 128 is passed through one of the smaller loops 122.

FIG. 17 is a perspective view of the fifth embodiment of the apparatus of this invention, showing the larger loop engaged with a door.

FIG. 18 is a perspective view of a sixth embodiment of the apparatus of this invention. In this embodiment, a cover sheet 130, made from a relatively thin sheet of metal, is formed to conform to the shape of the bracket 38 in order to cover the screws 36 that are screwed into the holes 34 in the strike plate 31. The cover sheet 130 prevents any of the screws 36 from being untightened or unscrewed by an outside party who is able to open the door 22 sufficiently. The cover sheet 130 can be engaged to the strike plate 31 by means of curved margins formed around the periphery of the strike plate 31 to prevent the cover sheet 103 from being pried away from the strike plate 31. The cover sheet 130 is retained against the bracket 38 by the screws 132.

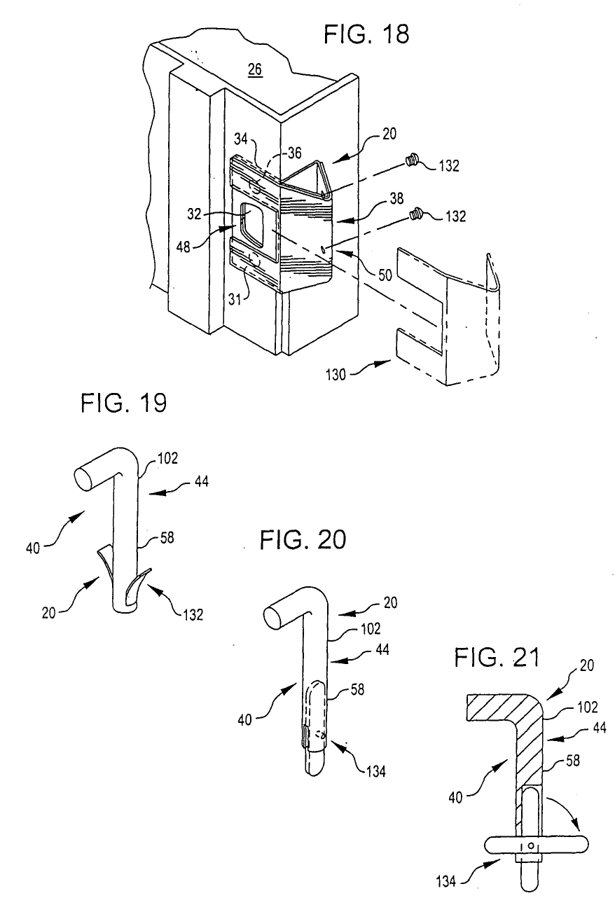

FIG. 19 is a perspective view of a seventh embodiment of the apparatus of this invention, FIG. 20 is a perspective view of an eighth embodiment of the apparatus of this invention, and FIG. 21 is a side view of the eighth embodiment of the apparatus of this invention, showing the transition of the toggle from an insertion position to an engaged position. In those embodiments that require use of a vertical cylinder 102 that is to be retained in the vertical shell 105, a spring 132 or a toggle 134 can be formed in the lower end of the vertical cylinder 102. The spring 132 can include two outwardly-biased spring steel leafs whose lower ends are fastened diametrically oppositely to the lower end of the vertical cylinder 102. In this configuration, the vertical cylinder 102 is placed into the vertical shell 105 which compresses the steel leafs until they pass completely through the vertical cylinder 102. At this point, the two leafs spring outwardly, engaging the vertical cylinder 102 with the vertical shell 105.

In the embodiment shown in FIGS. 20-21, the toggle 134 is aligned with the vertical cylinder 102 while it is being passed through the vertical shell 105. After the vertical cylinder 102 passes through the vertical shell 105, the toggle 134 becomes perpendicular to the vertical cylinder 102, preventing the vertical cylinder 102 from disengaging from the vertical shell 105.

FIG. 22 is a perspective view of a ninth embodiment of the apparatus of this invention, and FIG. 23 is a side view of the ninth embodiment of the apparatus of this invention, showing alternative positions of the S-bar in dashed lines. In this embodiment, the vertical cylinder 102 includes a projection 140 which follows a slot in its matching vertical shell 105. The projection 140 can be made from a hardened material and be press-fit into the vertical cylinder 102 (or in other ways that are known to those skilled in the relevant arts). The upper end of the vertical cylinder 102 is formed in the shape of a doughnut 142, which receives the upper horizontal portion of the S-bar 104. The doughnut portion includes a cam segment 144, and the upper horizontal portion of the S-bar 104 includes a projection 146 that rotates with the S-bar 104. As shown in FIG. 23, the S-bar 104 is rotated too far, the projection 146 impinges against the cam segment 144, stopping the rotation. If the rotation of the S-bar 104 is not limited (to, say, an angle that is no higher than approximately horizontal), it is possible for the apparatus 20 to engage the door 22 when it is not desired. For example, if it were possible to leave the S-bar 104 in the disengaged position upward against the jamb when an occupant leaves the room, the apparatus 20 to become engaged. Alternatively, a party could play a prank by deliberately causing the apparatus to become engaged when no one is located in the room. Limiting the angle of travel of the S-bar 104 to no more than slightly above horizontal will prevent this.

FIG. 24 is a perspective view of a tenth embodiment of the apparatus of this invention, showing the various fasteners used in connection with the tenth embodiment and a tool used to align the strike plate of the tenth embodiment. As discussed above, it is desirable to attach the bracket 38 to the jamb 26 using long screws or other fasteners, so that the bracket 38 is held by the shear strength of the fasteners. It is particularly advantageous to have longer, larger screws placed in the bracket 38 where it is most likely that an outsider would attempt to remove them. Fasteners that are less likely to be accessed by an outsider can be shorter, although it is desirable that they have finer threads than the longer fasteners.

The bracket 38 can be properly placed where the strike plate was previously located by means of the alignment tool 150. The alignment tool 150 is used to hold or mark the location of the innermost limit of the previous strike plate. Using this mark assures that the portion of the hole 32 that the door bolt bears against is exactly where the corresponding portion of the previous strike plate was located.

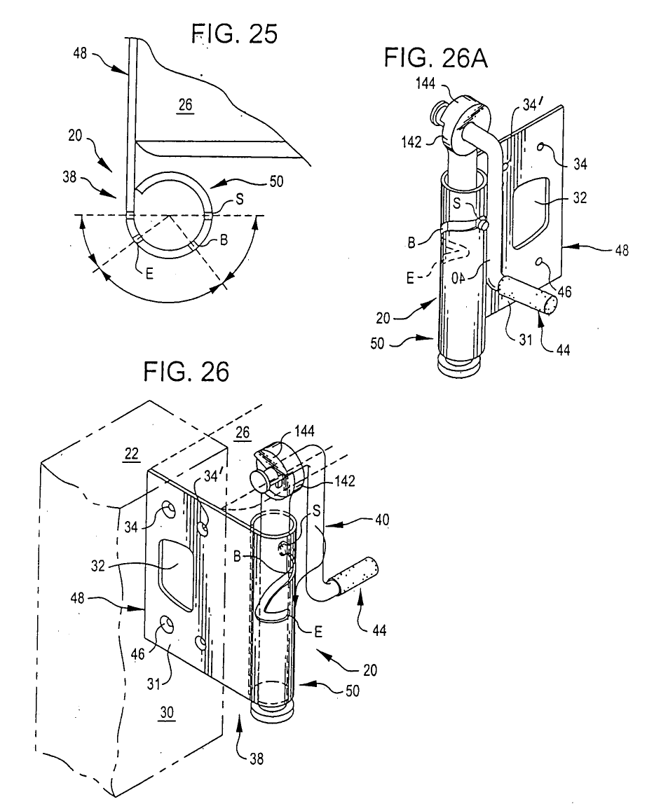

FIG. 25 is a top view of an eleventh embodiment of the apparatus of this invention, showing angular rotation of the cylindrical rod within the cylindrical shell of the invention.

FIG. 26 is a perspective view of the left side of the eleventh embodiment of the apparatus of this invention, showing constrained vertical and rotational movement of the cylindrical rod within the cylindrical shell of the invention. As shown in FIG. 25, the extreme of travel of the slot 112 when the apparatus 20 is in the disengaged position is designated by S, the angular location of the beginning portion of the slot 112 is designated by B, and the engaged position is designated by E.

FIG. 26A is a perspective view of the right side of the eleventh embodiment of the apparatus of this invention. From this view it is clear that the projection 140 cannot be cut or removed by an individual who is outside of the door or window 22.

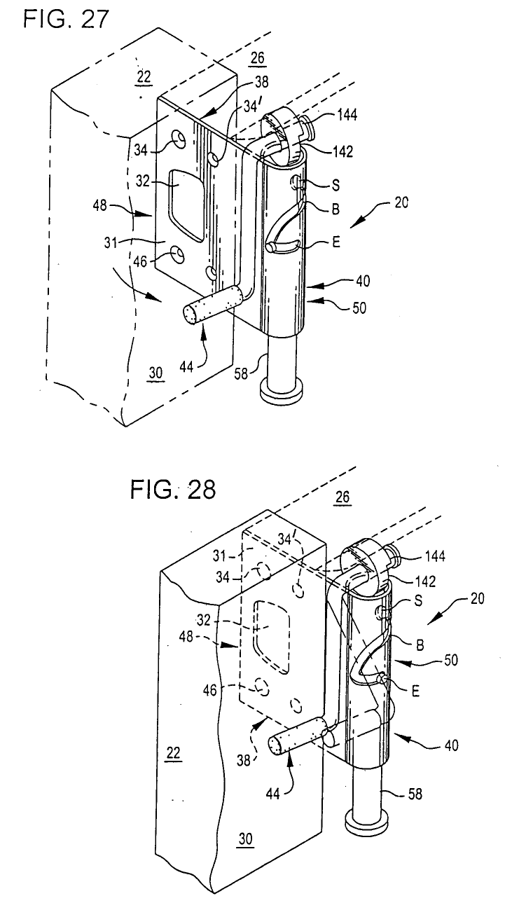

FIG. 27 is a perspective view of the left side of the eleventh embodiment of the apparatus of this invention, showing the cylindrical rod nearly fully engaged within the cylindrical shell of the invention, and the possible rotational movement of the S-bar of the invention.

FIG. 28 is a perspective view of the left side of the eleventh embodiment of the apparatus of this invention, showing the cylindrical rod fully engaged within the cylindrical shell of the invention.

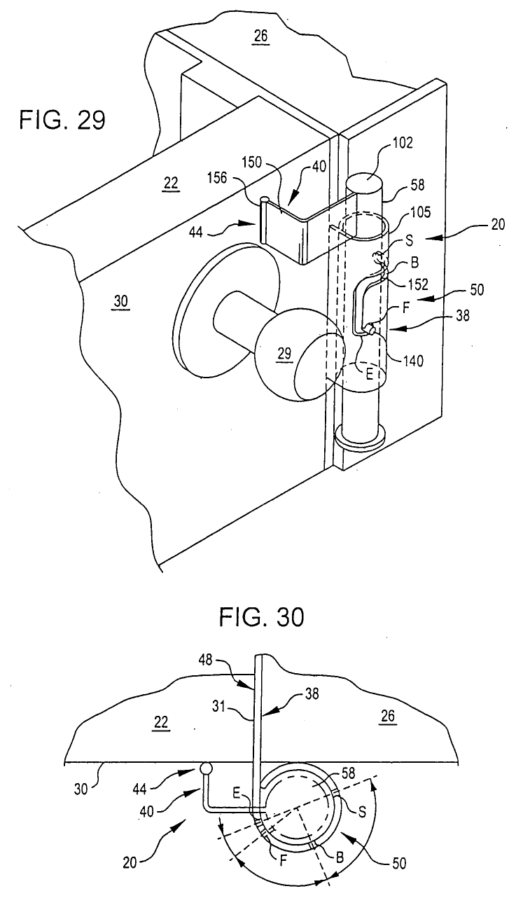

FIG. 29 is a perspective view of a twelfth embodiment of the apparatus of this invention, showing the apparatus in the engaged position. The apparatus 20 includes the vertical shell 105, the vertical cylinder 102, and engagement means 150. The vertical shell 105 has a slot 152 which guides the vertical cylinder 150 by means of the projection 140. The vertical cylinder 150 includes an arm 154′ that carries a projection surface 156 for contact with the door 22. When the apparatus 20 is in the engaged position, the projection surface 156 is held against the door because of the engagement of the projection 140 in the slot 152.

FIG. 30 is a top view of the twelfth embodiment of the apparatus of this invention, showing angular rotation of the cylindrical rod within the cylindrical shell of the invention.

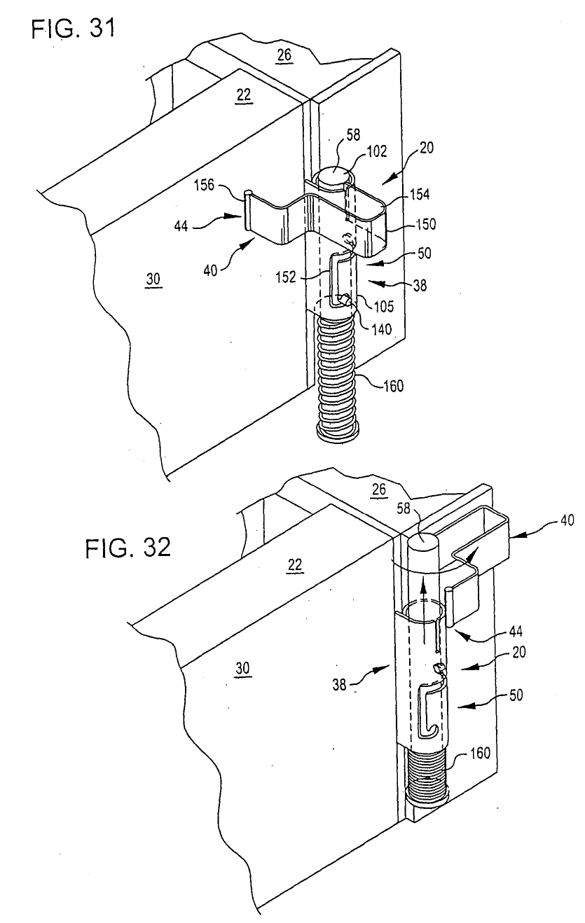

FIG. 31 is a perspective view of a thirteenth embodiment of the apparatus of this invention, showing the apparatus in the engaged position. The apparatus 20 includes the vertical shell 105, the vertical cylinder 102, and engagement means 150. The vertical shell 105 has a slot 152 which guides the vertical cylinder 150 by means of the projection 140. The vertical cylinder 150 includes a U-shaped arm 154 that carries a projection surface 156 for contact with the door 22. When the apparatus 20 is in the engaged position, the projection surface 156 is held against the door because of the engagement of the projection 140 in the slot 152. The vertical cylinder 102 is held in the engaged position by the action of the compressed coil spring 160.

FIG. 32 is a perspective view of the thirteenth embodiment of the apparatus of this invention, showing the upward and counter-clockwise movement of the apparatus needed to move the apparatus to the disengaged position. The vertical cylinder 102 is held in the disengaged position by the action of the compressed coil spring 160.

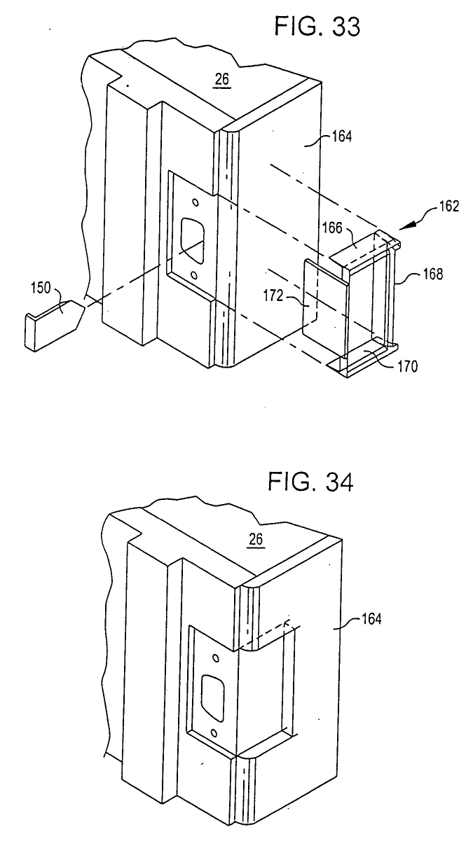

FIG. 33 is a perspective view of a tool for installation of various embodiments of the invention. The tool 162 is used to make an appropriate cut into a molding 164 so that the vertical cylinder 102 can be accommodated. The tool 162 essentially takes the form of three perpendicular chisels 166, 168 and 170, and a guide 172. The tool 162 is guided into the slot left by the strike plate forehand (which has been removed beforehand). The chisels parts of the tool 162 are then driven against the molding 164 to reduce the chance of splitting and to make an accurate cut.

FIG. 34 is a perspective view of the results of using the tool of FIG. 33.

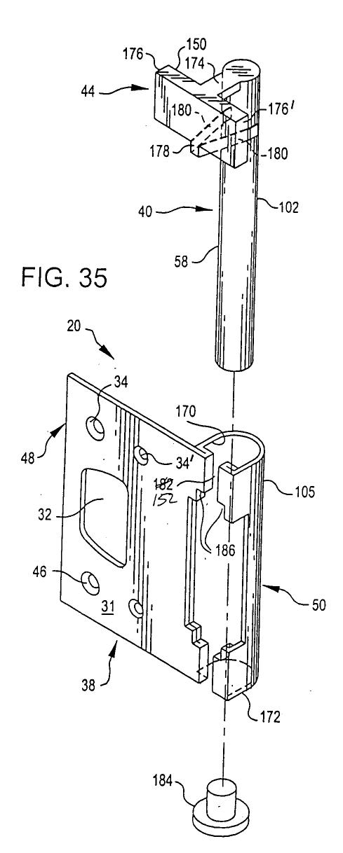

FIG. 35 is an exploded perspective view of a fourteenth embodiment of the apparatus of this invention. The apparatus 20 includes the vertical shell 105, the vertical cylinder 102, and engagement means 150. The vertical shell 105 includes an upper U-channel 170 portion and a lower U-channel portion 172. The two U-channel portions are mirror images, allowing the same apparatus 20 can be used with left- and right-handed doors. The engagement means 150 includes a first projection portion 174 that projects outwardly from the vertical cylinder 102. The first projection portion 174 supports two oppositely directed contact surfaces 176 and 176′ that are intended for contact with the surface of the door. The first projection portion 174 also supports a second projection portion 178. The ends of two leaf springs 180 are attached to the vertical cylinder 102 and reach toward and contact the second projection portion 178. As would be understood by those in the relevant arts, the biased springs 180 can be squeezed together to allow the engagement means 150 to pass through the slot 152 in the U-shaped portion 170. Releasing the biased springs 180 then captures the engagement means 150 in the vertical cylinder. When the apparatus 20 is in the engaged position, the projection surface 156 is held against the door. The vertical cylinder 102 is held in position by a bottom cap 184. If desired, the upper and lower U-channel portions 170 and 172 can be tapered or corrugated to strengthen them.

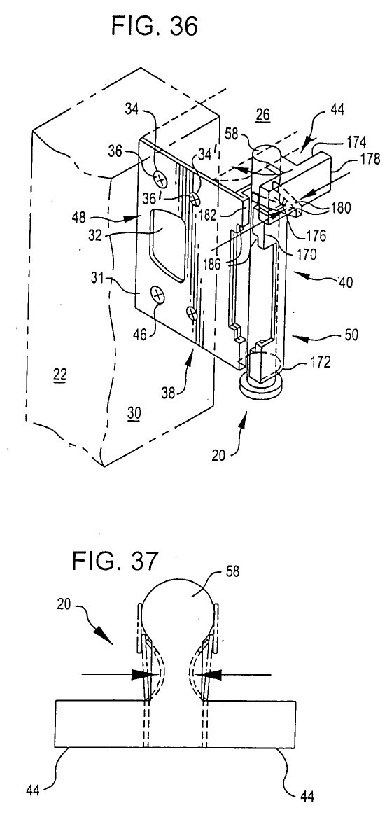

FIG. 36 is a perspective view of the fourteenth embodiment of the apparatus of this invention, showing the movements and actions necessary to move the apparatus from the disengaged position to the engaged position and to lock the apparatus in the engaged position. To move the apparatus 20 from the disengaged position to the engaged position, the vertical cylinder 102 should first be rotated clockwise (as seen from above). Next, the springs 180 are squeezed together sufficiently so that they will pass through the slot 152 until they engage the notches 186. The apparatus 20 is now in the engaged position. To revert the apparatus 20 to the disengaged position, the above operations should be performed in the opposite order.

FIG. 37 is a top view of the fourteenth embodiment of the apparatus of this invention, showing the squeezing action necessary to move the apparatus to the engaged position and to unlock the apparatus when it is in the engaged position.

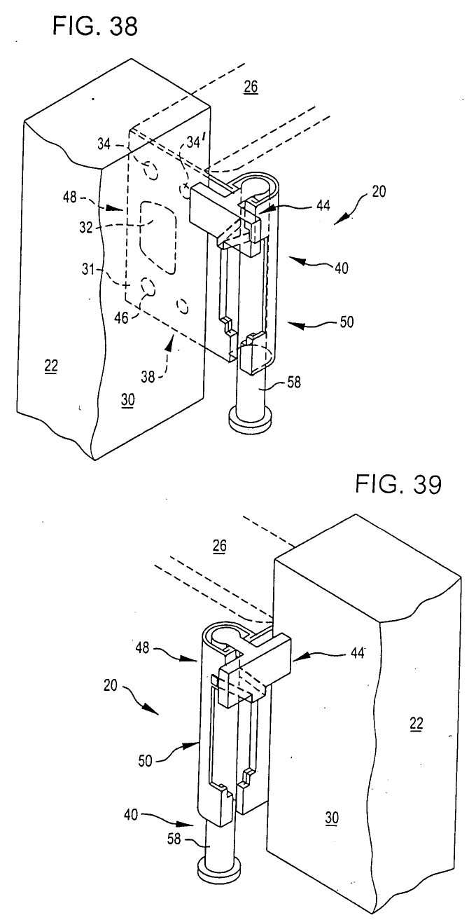

FIG. 38 is a phantom perspective view of the fourteenth embodiment of the apparatus of this invention, showing the apparatus in the engaged and locked position with a right hand door.

FIG. 39 is a perspective view of the fourteenth embodiment of the apparatus of this invention, showing the apparatus in the engaged and locked position with a left hand door.

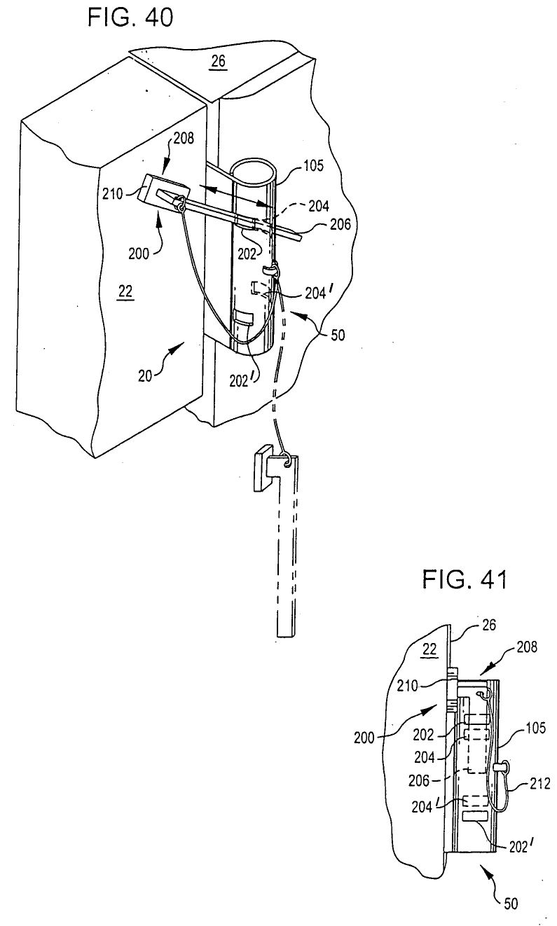

FIG. 40 is a perspective view of the fifteenth embodiment of the apparatus of this invention, and FIG. 41 is a side view of the fifteenth embodiment of the apparatus of this invention. The apparatus 20 includes a vertical shell 105 that is part of a strike plate as shown in FIG. 26. The apparatus 20 also includes a door engagement pin 200. The vertical shell 105 has an entry hole 202 and an exit hole 204 diametrically opposite, but below, the entry hole 202. A first end 206 of the engagement pin 200 is tapered to pass first through the entry hole 202 and then the exit hole 204 when the door engagement pin 200 is put in the engaged position. However, the taper of the engagement pin 200 is such that the engagement pin 200 stops with the second end 208 adjacent the door 22. The second end 208 of the door engagement pin 200 includes a door pad 210 that is placed near or against the door 22 when the door engagement pin 200 is in the engaged position. The door pad 210 may include a covering or coating that prevents marring the door 22 when the door engagement pin 200 is in the engaged position.

The door engagement pin 200 can be stored vertically in the vertical shell 105 when the apparatus 20 is not in the engaged position. Also and alternatively, the door engagement pin 200 can be attached to the vertical shell 105 by means of a cord or chain 212. In a further embodiment, the apparatus 20 can include additional entry and exit holes 202′ and 204′ placed at the lower end of the vertical shell 105. This enables the apparatus to be installed in a mirror-image position relative to the door 22 and jamb 26. If desired, the exit holes 202 and 202′ can be merged into a single exit hole.

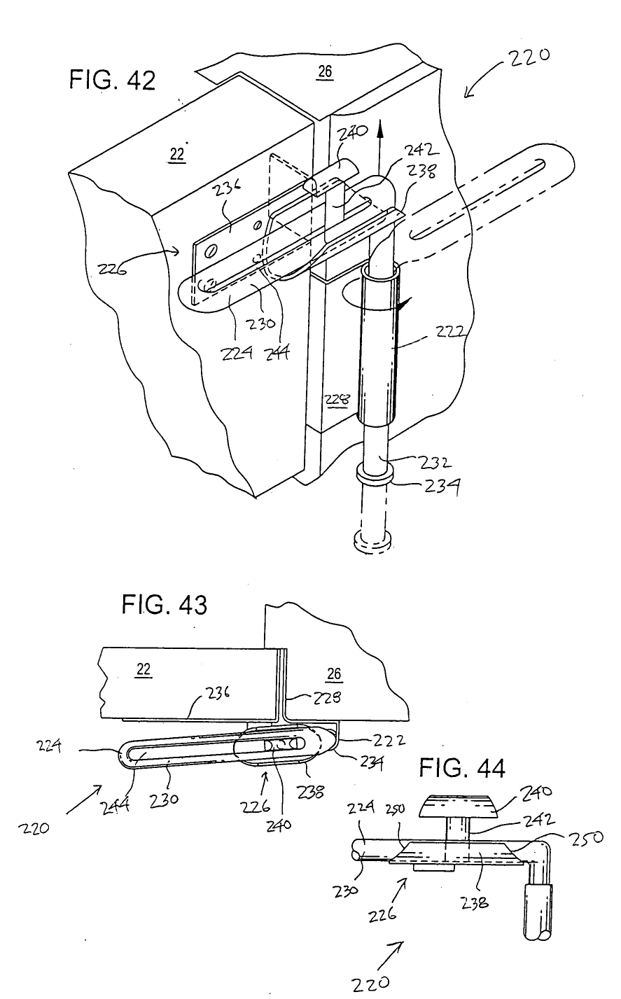

FIG. 42 is a perspective view of the sixteenth embodiment of the apparatus of this invention, FIG. 43 is a first side view of the sixteenth embodiment of the apparatus of this invention, and FIG. 44 is a first elevation view of the sixteenth embodiment of the apparatus of this invention. The apparatus 220 includes the cylindrical shell 222, a swinging bar 224, and securement 226. The cylindrical shell 222 is part of a plate 228 that also includes a strike plate, as discussed previously. The swinging bar 224 has a slotted portion 230 and a vertical bar 232 that passes through the cylindrical shell 222. The vertical bar 232 can move up and down within the cylindrical shell 222, but is restrained in its vertical motion by a restriction member 234, such as a flange, spring and/or toggle as described previously. The securement 226 includes a plate 236, a trough 238 attached to the plate 236, and an elevated button 240 attached to the trough 238 through a shaft 242.

The apparatus 220 is engaged by lifting and swinging the swinging bar 224 from its unsecured position (phantom lines) to its secured position, where the gap 244 in the swinging bar 224 is placed over the elevated button 240 and lowered into the trough 238. In this position the elevated button 240 is parallel to the gap 244, allowing the swinging bar 224 to rest in the trough 238.

The trough 238 is located aligned with the edge of the door 22 to prevent a thin card, such as a credit card from being moved upward within the space between the door 22 and the jamb 26 in order to establish where the swinging bar 224 is located and allowing the swinging bar 224 to be lifted from its secured position within the trough 238.

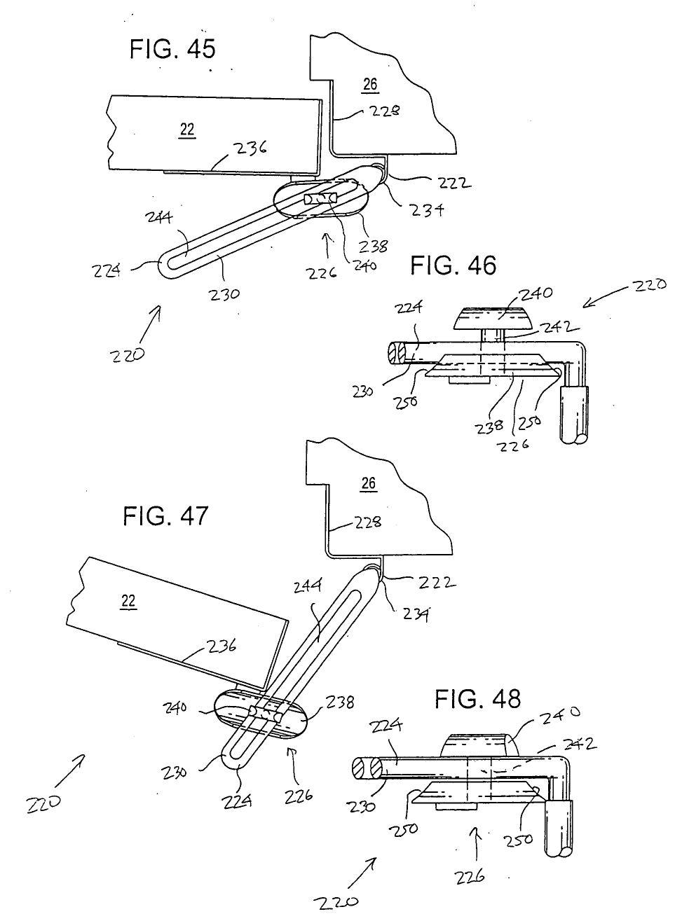

FIG. 45 is a second side view of the sixteenth embodiment of the apparatus of this invention, and FIG. 46 is a second elevation view of the sixteenth embodiment of the apparatus of this invention, showing the configuration of the apparatus 220 as the door 22 is just beginning to open. In this configuration, the button 240 is no longer parallel to the gap 224, preventing the swinging bar 224 from being lifted back over the button 240. The trough 238 has tapered ends 250 which begin to lift the swinging bar 220 from its rest position in the trough 238 as the door 22 begins to open.

FIG. 47 is a third side view of the sixteenth embodiment of the apparatus of this invention, and FIG. 48 is a third elevation view of the sixteenth embodiment of the apparatus of this invention, showing the configuration of the apparatus 220 as the door 22 is more fully open. In this configuration, the swinging bar 224 fully lifted above the bottom of the trough 238, but is still captured below the button 240.

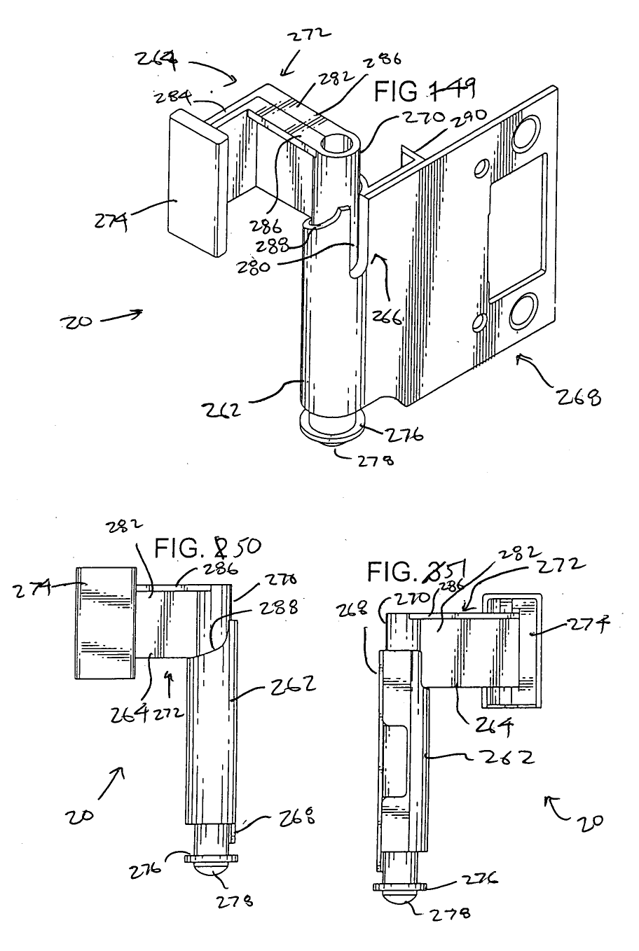

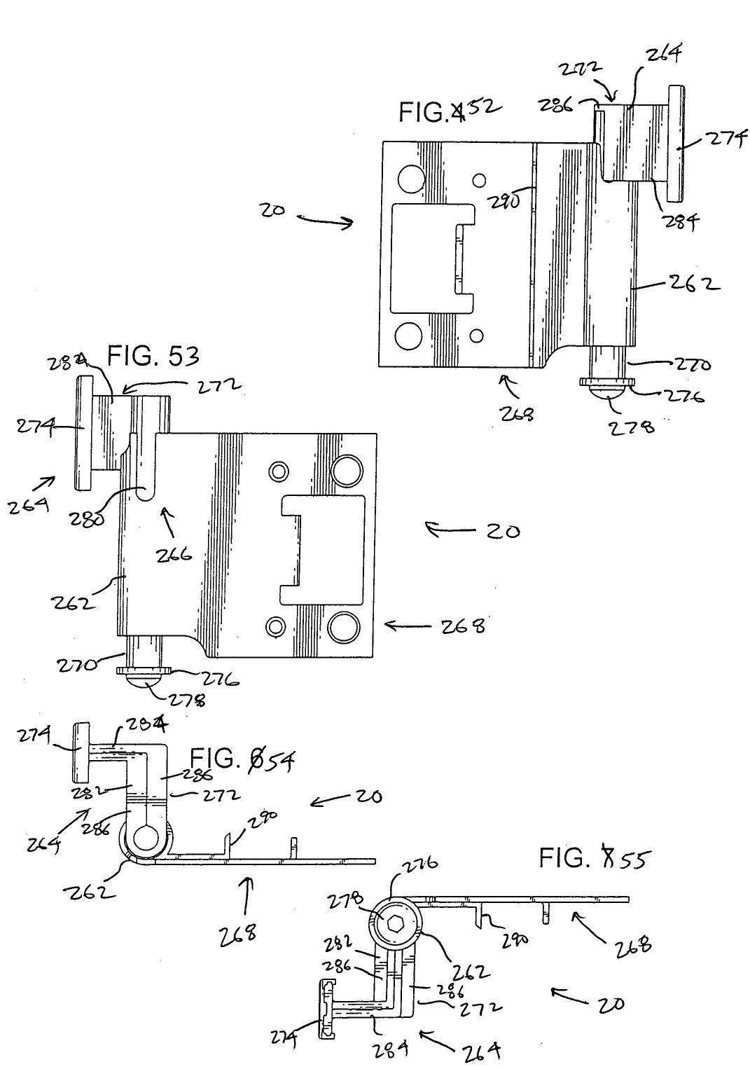

FIG. 49 is a first perspective view of the seventeenth embodiment of the apparatus of this invention showing my new design in a disengaged position, and FIG. 50 is a front view of the seventeenth embodiment of the apparatus of this invention showing my new design in the disengaged position. FIG. 51 is a rear view of the seventeenth embodiment of the apparatus of this invention showing my new design in the disengaged position, and FIG. 52 is a left side elevational view of the seventeenth embodiment of the apparatus of this invention showing my new design in the disengaged position. FIG. 53 is a right side elevational view of the seventeenth embodiment of the apparatus of this invention showing my new design in the disengaged position, FIG. 54 is a top view of the seventeenth embodiment of the apparatus of this invention showing my new design in the disengaged position, and FIG. 55 is a bottom view of the seventeenth embodiment of the apparatus of this invention showing my new design in the disengaged position.

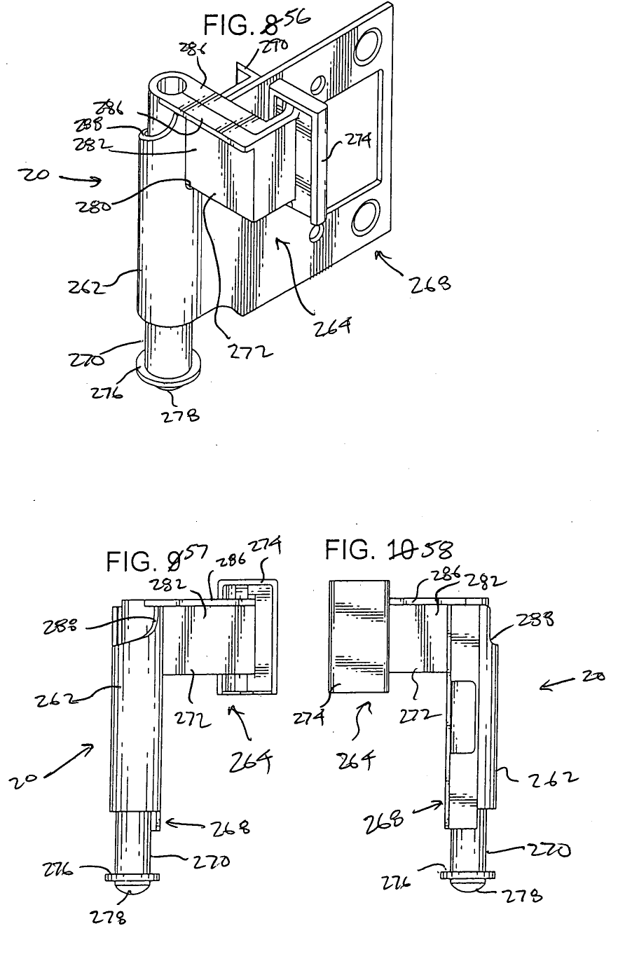

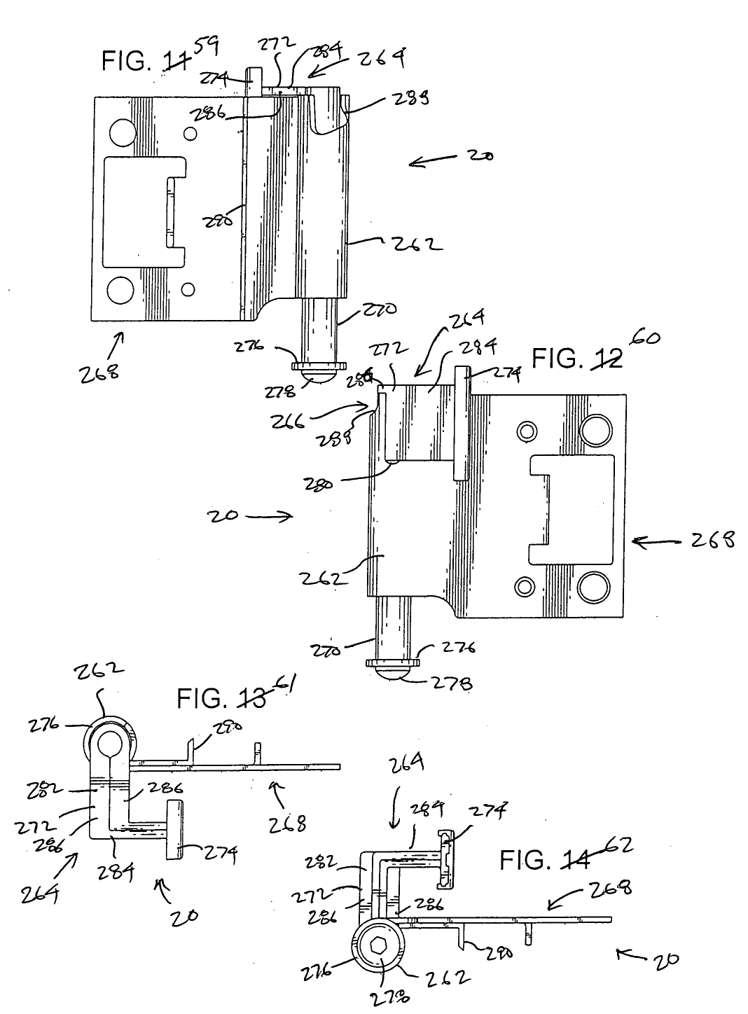

FIG. 56 is a second perspective view of the seventeenth embodiment of the apparatus of this invention showing my new design in an engaged position, and FIG. 57 is a front view of the seventeenth embodiment of the apparatus of this invention showing my new design in the engaged position. FIG. 58 is a rear view of the seventeenth embodiment of the apparatus of this invention showing my new design in the engaged position, and FIG. 59 is a left side elevational view of the seventeenth embodiment of the apparatus of this invention showing my new design in the engaged position. FIG. 60 is a right side elevational view of the seventeenth embodiment of the apparatus of this invention showing my new design in the engaged position, FIG. 61 is a top view of the seventeenth embodiment of the apparatus of this invention showing my new design in the disengaged position, and FIG. 62 is a bottom view of the seventeenth embodiment of the apparatus of this invention showing my new design in the engaged position.

The apparatus 20 includes a vertical shell 262, and swinging arm 264, and a securement 266. The vertical shell 262 is part of a plate 268 that also includes a strike plate, as discussed previously. The swinging arm 264 has a vertical cylinder 270, an extension 272, and a contact pad 274. The vertical cylinder 270 moves vertically within the vertical shell 262. The vertical motion of the vertical cylinder 270 is limited in the upper direction by an extension (such as a washer) 276, which is held in place by a fastener 278, such as a bolt with a conventional Allen drive portion. In the unsecured mode, the vertical motion of the vertical cylinder 270 is limited in the lower direction by the interaction of the swinging arm 264 with the upper portion of the vertical shell 262. In the secured mode, the vertical motion of the vertical cylinder 270 is limited in the lower direction by the interaction of the swinging arm 264 with the securement 266.

The extension 272 includes a first projection portion 282 and a second projection portion 284. The first projection portion 282 is connected between the upper portion of the vertical cylinder 270 and the second projection portion 284. The second projection portion 282 is connected between the first projection portion 282 and the contact pad 274. The contact pad 274 is preferably made from a material that will not scratch the surface of the door (not shown), such as Teflon®. The securement 266 includes a slot 280 that receives the extension 272.

If desired, the plate 268 can be made from a sheet of material, such as sheet metal that has been bent over on itself, as will be known by those skilled in the relevant arts. The plate 268 includes a flange 290. The flange 290 can be beveled so that it can be forced or otherwise forced under a molding. Also, if desired, the swinging arm 264 can be made from a sheet of material, such as sheet metal that has been bent over on itself, as will be known by those skilled in the relevant arts, to form a laminated structure. If desired, the first projection portion 282 can be provided with flanges 286. The flanges 286 considerably strengthen the swinging arm 264. The contact pad 274 is connected to the second projection portion 282 by conventional means, such as a sliding engagement between the contact pad 274 and the second projection portion 284.

The apparatus 20 is engaged by lifting and swinging the swinging bar 224 from its unsecured position to its secured position where the first projection portion 282 falls into the slot 280. The apparatus 20 is disengaged by lifting and swinging the swinging bar 224 from its secured position to its unsecured position, lifting the first projection portion 282 out of the slot 280 and lowering the swinging bar 224 on the inclined surface 288.

One should understand that the drawings are not necessarily to scale and the elements are sometimes illustrated by graphic symbols, phantom lines, diagrammatic representations and fragmentary views. In some instances, details may be omitted which are not necessary for an understanding of the current invention or which render other details difficult to perceive.

If desired, the apparatus 20 of this invention may have any desired shape or configuration. By way of example, but not by limitation, the first bracket 38 and the second bracket 80 may alternatively have: a triangular shape; an oval shape, a round shape; a hexagonal shape; a bell shape; the shape of a cartoon character or animal; the shape of a person or inanimate object; or any other desired shape.

If desired, the apparatus 20 of this invention may be custom designed and manufactured to personalize the apparatus to fit a particular need. Consequently, the apparatus of this invention may be given as a gift.

The apparatus 20 may also be manufactured from a wide variety of different materials, such as from metal, plastic, mesh material, durable fabric, graphite, wire, a combination of wires, composite material or any other desired material.

The apparatus 20 of this invention may also be manufactured from materials that are opaque, transparent, translucent or even that glow-in-the-dark. If the apparatus is manufactured from a material that glows in the dark, or if a glow-in-the-dark material is applied to, incorporated into or painted onto the apparatus 20, it will be easier for the user to locate and remove the barrier 44 therefrom when this becomes necessary at dark periods or in the middle of the night.

The means and construction disclosed herein are by way of example and comprise primarily the preferred and several alternative forms of putting the invention into effect.

Although the drawings depict the preferred and several alternative embodiments of this invention, other embodiments are described within the preceding and following text. One skilled in the art will appreciate that the disclosed apparatus may have a wide variety of different designs, shapes and configurations. Additionally, persons skilled in the art to which this invention pertains might consider the Foregoing teachings in making various modifications, other embodiments and alternative forms of this invention.

It is, therefore, to be understood that the claimed invention is not limited to the particular embodiments or specific features shown herein. To the contrary, the inventor claims the invention in all of its various forms, including all alternatives, modifications, equivalents and alternative embodiments which fall within the legitimate and valid scope of the appended Claims, appropriately interpreted under the Doctrine of Equivalents.

### INDUSTRIAL APPLICABILITY

This invention may be used within any apartment, dwelling, residence, home, hotel room, motel room, meeting hall, convention center, school, university, church, bank, office building, business, factory, retail store, restaurant, bar, tavern, ocean liner, ship, yacht, boat, sailboat, submarine, airplane cockpit and/or within any other building, vehicle or vessel, wherein the occupant desires to bar a pivotal door or window against unauthorized opening or entry. It is anticipated that other applications and/or uses for the apparatus of this invention could easily be found.

1. An apparatus for selectively barring or securing a hinged door or window against being pivoted from a closed or partially closed position to an open position, the door or window having at least one hinge and having a latch bolt or dead bolt adapted to operatively secure the door or window to a jamb when in the closed position, the jamb having a strike plate capable of being secured or mounted to the jamb generally adjacent to the latch bolt or dead bolt when the door or window is in the closed position, the strike plate having a bolt hole, aperture or recess into which a portion of the latch bolt or dead bolt may be received, the strike plate having at least one hole or aperture through which a screw, bolt, nail, pin, rivet or weld may pass to secure or mount the strike plate to the jamb, said apparatus comprising a combination of:
(a) an elongated first bracket having a proximal end and an opposed distal end, said first bracket having at least one strike plate hole, aperture, loop, orifice or slot positioned near said proximal end thereof through or into which at least a portion of the screw, bolt, nail, pin, rivet or weld is capable of passing to secure the proximal end of the first bracket to the jamb, at least a portion of said distal end of said first bracket extending outwardly away from the jamb and the strike plate; and
(b) a barrier or stop element capable of selectively and removably engaging said first bracket near said distal end thereof to at least partially block pivotal movement of the door or window relative to the strike plate when the door or window is in the closed or partially closed position and said barrier or stop element operatively engages said first bracket.

2. The apparatus of claim 1, wherein the barrier or stop element includes a serial plurality of loops in a cord or cable, a first end of the barrier or stop element being attached to a cylindrical L-shaped rod, the rod being adapted to be passed through one of the plurality of loops to form a larger loop that encircles a fixture attached to the door or window, the rood then being engaged with the elongated first bracket.

3. The apparatus of claim 1, wherein said first bracket has at least one barrier hole, aperture, loop, orifice or slot positioned near said distal end thereof through or into which at least a portion of said barrier or stop element may be selectively inserted and retained.

4. The apparatus of claim 1, wherein the hole in the elongated first bracket is vertical.

5. The apparatus of claim 4, wherein the vertical hole has a triangular cross-section.

6. The apparatus of claim 5, wherein the upper and lower ends of the vertical hole are tapered.

7. The apparatus of claim 5, wherein the vertical cylinder is retained by a horizontal pin.

8. The apparatus of claim 1, wherein the first bracket is held by a plurality of fasteners.

9. The apparatus of claim 8, wherein the plurality of fasteners include two subpluralities of fasteners, a first subplurality being used closer to a door stop attached to the jamb, and a second subplurality being used farther from the door stop, the fasteners in the first subplurality being larger that the fasteners in the second subplurality.

10. The apparatus of claim 9, wherein the fasteners in the first and second subpluralities are difficult to remove once they are attached.

11. The apparatus of claim 1, wherein the barrier or stop element includes a vertical cylindrical rod.

12. The apparatus of claim 11, wherein the cylindrical rod has an engagement means at its lower end.

13. The apparatus of claim 11, wherein the cylindrical rod is L-shaped.

14. The apparatus of claim 13, wherein the upper end of the L-shaped rod includes means to limit the angle by which the L-shaped rod can swing relative to the cylindrical rod.

15. The apparatus of claim 11, wherein the vertical rod has an extension at its upper end, the extension being toward the door.

16. The apparatus of claim 15, wherein the vertical rod includes a biased element to retain the vertical position of the vertical rod in the engaged position.

17. The apparatus of claim 11, wherein the first bracket has an upper U-shaped portion to retain the vertical cylinder.

18. The apparatus of claim 17, wherein the U-shaped portion is corrugated or flared to strengthen the U-shaped portion.

19. The apparatus of claim 11, wherein the cylindrical rod has a projection that follows a path in the first bracket.

20. The apparatus of claim 1, wherein said barrier or stop element comprises a rigid or semi-rigid object which can be quickly and easily removed from engagement with the first bracket.

21. The apparatus of claim 20, wherein said barrier or stop element comprises a bar, bolt, padlock, pin, carabineer, clip, snap, snap shackle, shackle, hook, piton or screwdriver which is capable of being at least partially inserted into said first barrier hole, aperture or loop to at least partially block pivotal movement of the door or windows relative to the strike plate when the door or window is in the closed or partially closed position.

22. The apparatus of claim 1, further comprising an elongated second bracket having a proximal end and an opposed distal end, said second bracket having at least one strike plate hole, aperture, loop, orifice or slot positioned near said proximal end thereof through or into which at least a portion of the screw, bolt, nail, pin, rivet or weld is capable of passing to secure the proximal end of the second bracket to the jamb, at least a portion of said distal end of said second bracket extending outwardly away from the jamb and the strike pate, said barrier or stop element capable of selectively and removably engaging said second bracket near said distal end thereof.

23. The apparatus of claim 22, wherein said second bracket has at least one barrier hole, aperture, loop, orifice or slot positioned near said distal end thereof through or into which at least a portion of said barrier or stop element may be selectively inserted and retained.

24. A method for selectively barring or securing a hinged door or window against being pivoted from a closed or partially closed position to an open position, the door or window having at least one hinge and having a latch bolt or dead bolt adapted to operatively secure the door or window to a jamb when in the closed position, the jamb having a strike plate capable of being secured or mounted to the jamb generally adjacent to the latch bolt or dead bolt when the door or window is in the closed position, the strike plate having a bolt hole, aperture or recess into which a portion of the latch bolt or dead bolt may be received, the strike plate having at least one hole or aperture through which a screw, bolt, nail, pin, rivet or weld may pass to secure or mount the strike plate to the jamb, said method comprising the steps of:
(a) connecting an elongated first bracket having a proximal end and an opposed distal end to the jamb, said first bracket having at least one strike plate hole, aperture, loop, orifice or slot positioned near said proximal end thereof through or into which at least a portion of the screw, bolt, nail, pin, rivet or weld is capable of passing to secure the proximal end of the first bracket to the jamb, at least a portion of said distal end of said first bracket extending outwardly away from the jamb and the strike plate; and
(b) selectively and removably engaging a barrier or stop element to said first bracket near said distal end thereof to at least partially block pivotal movement of the door or window relative to the strike plate when the door or window is in the closed or partially closed position and said barrier or stop element operatively engages said first bracket.

25. The method of claim 24, wherein the barrier or stop element includes a serial plurality of loops in a cord or cable, a first end of the barrier or stop element being attached to a cylindrical L-shaped rod, the method further including the steps of:
(c) passing the rod through one of the plurality of loops to form a larger loop; and
(d) placing the larger loop around a fixture attached to the door or window, thereby engaging the rod with the elongated first bracket.

26. The method of claim 24, wherein said first bracket has at least one barrier hole, aperture, loop, orifice or slot positioned near said distal end thereof through or into which at least a portion of said barrier or stop element may be selectively inserted and retained.

27. The method of claim 24, wherein the hole in the elongated first bracket is vertical.

28. The method of claim 27, wherein the vertical hole has a triangular cross-section.

29. The method of claim 28, wherein the upper and lower ends of the vertical hole are tapered.

30. The method of claim 28, wherein the vertical cylinder is retained by a horizontal pin.

31. The method of claim 24, wherein the first bracket is held by a plurality of fasteners.

32. The method of claim 31, wherein the plurality of fasteners include two subpluralities of fasteners, a first subplurality being used closer to a door stop attached to the jamb, and a second subplurality being used farther from the door stop, the fasteners in the first subplurality being larger that the fasteners in the second subplurality.

33. The method of claim 32, wherein the fasteners in the first and second subpluralities are difficult to remove once they are attached.

34. The method of claim 24, wherein the barrier or stop element includes a vertical cylindrical rod.

35. The method of claim 34, wherein the cylindrical rod has an engagement means at its lower end.

36. The method of claim 34, wherein the cylindrical rod is L-shaped.

37. The method of claim 36, wherein the upper end of the L-shaped rod includes means to limit the angle by which the L-shaped rod can swing relative to the cylindrical rod.

38. The method of claim 34, wherein the vertical rod has an extension at its upper end, the extension being toward the door.

39. The method of claim 38, wherein the vertical rod includes a biased element to retain the vertical position of the vertical rod in the engaged position.

40. The method of claim 34, wherein the first bracket has an upper U-shaped portion to retain the vertical cylinder.

41. The method of claim 40, wherein the U-shaped portion is corrugated or flared to strengthen the U-shaped portion.

42. The method of claim 34, wherein the cylindrical rod has a projection that follows a path in the first bracket.

43. The method of claim 24, wherein said barrier or stop element comprises a rigid or semi-rigid object which can be quickly and easily removed from engagement with the first bracket.

44. The method of claim 43, wherein said barrier or stop element comprises a bar, bolt, padlock, pin, carabineer, clip, snap, snap shackle, shackle, hook, piton or screwdriver which is capable of being at least partially inserted into said first barrier hole, aperture or loop to at least partially block pivotal movement of the door or windows relative to the strike plate when the door or window is in the closed or partially closed position.

45. The method of claim 24, further comprising an elongated second bracket having a proximal end and an opposed distal end, said second bracket having at least one strike plate hole, aperture, loop, orifice or slot positioned near said proximal end thereof through or into which at least a portion of the screw, bolt, nail, pin, rivet or weld is capable of passing to secure the proximal end of the second bracket to the jamb, at least a portion of said distal end of said second bracket extending outwardly away from the jamb and the strike pate, said barrier or stop element capable of selectively and removably engaging said second bracket near said distal end thereof.

46. The method of claim 45, wherein said second bracket has at least one barrier hole, aperture, loop, orifice or slot positioned near said distal end thereof through or into which at least a portion of said barrier or stop element may be selectively inserted and retained.

47. An apparatus for selectively barring or securing a hinged door or window against being pivoted from a closed or partially closed position to an open position, the door or window having at least one hinge and having a latch bolt or dead bolt adapted to operatively secure the door or window to a jamb when in the closed position, the jamb having a strike plate capable of being secured or mounted to the jamb generally adjacent to the latch bolt or dead bolt when the door or window is in the closed position, the strike plate having a bolt hole, aperture or recess into which a portion of the latch bolt or dead bolt may be received, the strike plate having at least one hole or aperture through which a screw, bolt, nail, pin, rivet or weld may pass to secure or mount the strike plate to the jamb, said apparatus comprising:
(a) means for connecting an elongated first bracket having a proximal end and an opposed distal end to the jamb, said first bracket having at least one strike plate hole, aperture, loop, orifice or slot positioned near said proximal end thereof through or into which at least a portion of the screw, bolt, nail, pin, rivet or weld is capable of passing to secure the proximal end of the first bracket to the jamb, at least a portion of said distal end of said first bracket extending outwardly away from the jamb and the strike plate; and
(b) means for selectively and removably engaging a barrier or stop element to said first bracket near said distal end thereof to at least partially block pivotal movement of the door or window relative to the strike plate when the door or window is in the closed or partially closed position and said barrier or stop element operatively engages said first bracket.

48. The apparatus of claim 47, wherein the barrier or stop element includes a serial plurality of loops in a cord or cable, a first end of the barrier or stop element being attached to a cylindrical L-shaped rod, the apparatus further comprising:
(c) means for passing the rod through one of the plurality of loops to form a larger loop; and
(d) means for placing the larger loop around a fixture attached to the door or window, thereby engaging the rod with the elongated first bracket.
